(19) United States
(12) Patent Application Publication
(10) Pub. No.: US 2024/0235910 A9
(43) Pub. Date: Jul. 11, 2024

(54) TECHNIQUES FOR ENHANCED SOUNDING REFERENCE SIGNAL MULTIPLEXING

(71) Applicant: QUALCOMM Incorporated, San Diego, CA (US)

(72) Inventors: Weimin Duan, San Diego, CA (US); Jing Jiang, San Diego, CA (US); Yu Zhang, San Diego, CA (US); Wei Yang, San Diego, CA (US); Seyedkianoush Hosseini, San Diego, CA (US)

(21) Appl. No.: 18/048,778

(22) Filed: Oct. 21, 2022

(51) Int. Cl. H04L 27/26; H04L 5/00

(52) U.S. Cl. CPC H04L 27/2613; H04L 5/0051

(57) ABSTRACT

Techniques and devices for wireless communications are described. A user equipment (UE) may receive a configuration from a network entity for multiplexing a reference signal with a data signal in time and in frequency or for multiplexing the reference signal in a Doppler domain. The UE may receive an assignment of multiple time-frequency resources from the network entity for transmission of the reference signal. The UE may multiplex the reference signal across the assigned time-frequency resources in accordance with the received configuration. The UE may transmit the multiplexed reference signal to the network entity.

### FIELD OF DISCLOSURE

The present disclosure, for example, relates to wireless communication systems, more particularly to techniques for enhanced sounding reference signal (SRS) multiplexing.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). A network entity may perform a channel estimation procedure using reference signals transmitted from a UE. In some cases, existing techniques for transmission of such reference signals may be deficient.

### SUMMARY

The described techniques relate to improved devices and apparatuses that support techniques for enhanced sounding reference signal (SRS) multiplexing. For example, the described techniques provide a framework for multiplexing reference signals. In some examples, a user equipment (UE) may receive a configuration from a network entity for multiplexing an SRS with a data signal in time and in frequency. In such examples, the UE may receive an assignment of multiple time-frequency resources from the network entity for transmission of the SRS. Additionally, or alternatively, in such examples, the UE may multiplex the SRS with the data signal across the assigned time-frequency resources in accordance with the received configuration and transmit the multiplexed SRS to the network entity.

In some other examples, the UE may receive a configuration from the network entity for multiplexing multiple reference signals in a Doppler domain. In such examples, the UE may receive an assignment of multiple time-frequency resources for transmission of the multiple reference signals. Additionally, or alternatively, in such examples, the UE may multiplex the multiple reference signals across the assigned time-frequency resources in accordance with the received configuration and transmit the multiplexed reference signals to the network entity.

A method for wireless communication at a UE is described. The method may include receiving, from a network entity, a configuration for multiplexing a SRS with a data signal in time and in frequency, receiving, from the network entity, an assignment of a set of multiple time-frequency resources for transmission of the SRS, multiplexing the SRS with the data signal across the assigned set of multiple time-frequency resources in accordance with the received configuration, and transmitting, to the network entity, the multiplexed SRS.

An apparatus for wireless communication at a UE is described. The apparatus may include a processor, memory coupled with the processor, and instructions stored in the memory. The instructions may be executable by the processor to cause the apparatus to receive, from a network entity, a configuration for multiplexing a SRS with a data signal in time and in frequency, receive, from the network entity, an assignment of a set of multiple time-frequency resources for transmission of the SRS, multiplex the SRS with the data signal across the assigned set of multiple time-frequency resources in accordance with the received configuration, and transmit, to the network entity, the multiplexed SRS.

Another apparatus for wireless communication at a UE is described. The apparatus may include means for receiving, from a network entity, a configuration for multiplexing a SRS with a data signal in time and in frequency, means for receiving, from the network entity, an assignment of a set of multiple time-frequency resources for transmission of the SRS, means for multiplexing the SRS with the data signal across the assigned set of multiple time-frequency resources in accordance with the received configuration, and means for transmitting, to the network entity, the multiplexed SRS.

A non-transitory computer-readable medium storing code for wireless communication at a UE is described. The code may include instructions executable by a processor to receive, from a network entity, a configuration for multiplexing a SRS with a data signal in time and in frequency, receive, from the network entity, an assignment of a set of multiple time-frequency resources for transmission of the SRS, multiplex the SRS with the data signal across the assigned set of multiple time-frequency resources in accordance with the received configuration, and transmit, to the network entity, the multiplexed SRS.

In some examples of the method, apparatuses, and non-transitory computer-readable medium described herein, multiplexing the SRS with the data signal may include operations, features, means, or instructions for receiving, from the network entity, an indication to rate-match the data signal around the SRS, rate-matching the data signal around the SRS in response to receiving the indication, and multiplexing the SRS with the rate-matched data signal across the assigned set of multiple time-frequency resources.

In some examples of the method, apparatuses, and non-transitory computer-readable medium described herein, rate-matching the data signal around the SRS may include operations, features, means, or instructions for receiving, from the network entity, an indication of a comb pattern that identifies resource blocks within the assigned set of multiple time-frequency resources to be used at the UE for transmission of the SRS and rate-matching the data signal around the SRS across the assigned set of multiple time-frequency resources in accordance with the indicated comb pattern.

In some examples of the method, apparatuses, and non-transitory computer-readable medium described herein, multiplexing the SRS with the data signal may include operations, features, means, or instructions for receiving, from the network entity, an indication of a comb pattern and frequency offset associated with the comb pattern that identify resource blocks within the assigned set of multiple time-frequency resources to be used at the UE for transmission of the SRS and multiplexing the SRS with the data signal across the assigned set of multiple time-frequency resources in accordance with the indicated comb pattern and frequency offset.

In some examples of the method, apparatuses, and non-transitory computer-readable medium described herein, multiplexing the SRS with the data signal may include operations, features, means, or instructions for encoding the SRS using a first cover code, encoding the data signal using a second cover code that may be orthogonal to the first cover code, and multiplexing the SRS with the data signal across the assigned set of multiple time-frequency resources.

In some examples of the method, apparatuses, and non-transitory computer-readable medium described herein, multiplexing the SRS with the data signal may include operations, features, means, or instructions for multiplexing the SRS with the data signal and at least one demodulation reference signal (DMRS) across the assigned set of multiple time-frequency resources.

In some examples of the method, apparatuses, and non-transitory computer-readable medium described herein, multiplexing the SRS with the data signal may include operations, features, means, or instructions for receiving, from the network entity, an indication of resource blocks within the assigned set of multiple time-frequency resources to be used at the UE for transmission of the SRS and multiplexing the SRS with the data signal across the indicated resource blocks within the assigned set of multiple time-frequency resources, where the SRS occupies a first portion of indicated resource blocks and the data signal occupies a second portion of the indicated resource blocks.

Some examples of the method, apparatuses, and non-transitory computer-readable medium described herein may further include operations, features, means, or instructions for estimating, at the network entity, a channel for wireless communications between the UE and the network entity, sensing, at the network entity; an environment associated with the UE, and identifying, at the network entity, a position of the UE.

In some examples of the method, apparatuses, and non-transitory computer-readable medium described herein, the data signal includes a physical uplink control channel (PUCCH) signal or a physical uplink shared channel (PUSCH) signal.

A method for wireless communication at a UE is described. The method may include receiving, from a network entity, a configuration for multiplexing a set of multiple reference signals in a Doppler domain, receiving, from the network entity, an assignment of a set of multiple time-frequency resources for transmission of the set of multiple reference signals, multiplexing the set of multiple reference signals across the assigned set of multiple time-frequency resources in accordance with the received configuration, and transmitting, to the network entity, the multiplexed set of multiple reference signals.

An apparatus for wireless communication at a UE is described. The apparatus may include a processor, memory coupled with the processor, and instructions stored in the memory. The instructions may be executable by the processor to cause the apparatus to receive, from a network entity, a configuration for multiplexing a set of multiple reference signals in a Doppler domain, receive, from the network entity, an assignment of a set of multiple time-frequency resources for transmission of the set of multiple reference signals, multiplex the set of multiple reference signals across the assigned set of multiple time-frequency resources in accordance with the received configuration, and transmit, to the network entity, the multiplexed set of multiple reference signals.

Another apparatus for wireless communication at a UE is described. The apparatus may include means for receiving, from a network entity, a configuration for multiplexing a set of multiple reference signals in a Doppler domain, means for receiving, from the network entity, an assignment of a set of multiple time-frequency resources for transmission of the set of multiple reference signals, means for multiplexing the set of multiple reference signals across the assigned set of multiple time-frequency resources in accordance with the received configuration, and means for transmitting, to the network entity, the multiplexed set of multiple reference signals.

A non-transitory computer-readable medium storing code for wireless communication at a UE is described. The code may include instructions executable by a processor to receive, from a network entity, a configuration for multiplexing a set of multiple reference signals in a Doppler domain, receive, from the network entity, an assignment of a set of multiple time-frequency resources for transmission of the set of multiple reference signals, multiplex the set of multiple reference signals across the assigned set of multiple time-frequency resources in accordance with the received configuration, and transmit, to the network entity, the multiplexed set of multiple reference signals.

In some examples of the method, apparatuses, and non-transitory computer-readable medium described herein, multiplexing the set of multiple reference signals may include operations, features, means, or instructions for receiving, from the network entity, an indication of a set of multiple phase codes for multiplexing the set of multiple reference signals in the Doppler domain and multiplexing the set of multiple reference signals using the indicated set of multiple phase codes.

In some examples of the method, apparatuses, and non-transitory computer-readable medium described herein, multiplexing the set of multiple reference signals using the indicated set of multiple phase codes may include operations, features, means, or instructions for multiplying each reference signal of the set of multiple reference signals with a respective phase code of the indicated set of multiple phase codes.

In some examples of the method, apparatuses, and non-transitory computer-readable medium described herein, each respective phase code may be based on a respective antenna port of set of multiple antenna ports at the UE and a respective symbol within the assigned set of multiple time-frequency resources.

Some examples of the method, apparatuses, and non-transitory computer-readable medium described herein may further include operations, features, means, or instructions for estimating, at the network entity, a channel for wireless communications between the UE and the network entity, sensing, at the network entity, an environment associated with the UE, and identifying, at the network entity, a position of the UE.

In some examples of the method, apparatuses, and non-transitory computer-readable medium described herein, the set of multiple reference signals include SRSs, positioning reference signals (PRSs), or sensing reference signals.

A method for wireless communication at a network entity is described. The method may include outputting, to a UE, a configuration for multiplexing a SRS with a data signal in time and in frequency, outputting, to the UE, an assignment of a set of multiple time-frequency resources for transmission of the SRS, and obtaining, from the UE, the SRS and the data signal, where the obtained SRS is multiplexed with the obtained data signal across the assigned set of multiple time-frequency resources in accordance with the output configuration.

An apparatus for wireless communication at a network entity is described. The apparatus may include a processor, memory coupled with the processor, and instructions stored in the memory. The instructions may be executable by the processor to cause the apparatus to outputting, to a UE, a configuration for multiplex a SRS with a data signal in time and in frequency, outputting, to the UE, an assignment of a set of multiple time-frequency resources for transmission of the sound reference signal, and obtain, from the UE, the SRS and the data signal, where the obtained SRS is multiplexed with the obtained data signal across the assigned set of multiple time-frequency resources in accordance with the output configuration.

Another apparatus for wireless communication at a network entity is described. The apparatus may include means for outputting, to a UE, a configuration for multiplexing a SRS with a data signal in time and in frequency, means for outputting, to the UE, an assignment of a set of multiple time-frequency resources for transmission of the SRS, and means for obtaining, from the UE, the SRS and the data signal, where the obtained SRS is multiplexed with the obtained data signal across the assigned set of multiple time-frequency resources in accordance with the output configuration.

A non-transitory computer-readable medium storing code for wireless communication at a network entity is described. The code may include instructions executable by a processor to outputting, to a UE, a configuration for multiplex a SRS with a data signal in time and in frequency, outputting, to the UE, an assignment of a set of multiple time-frequency resources for transmission of the sound reference signal, and obtain, from the UE, the SRS and the data signal, where the obtained SRS is multiplexed with the obtained data signal across the assigned set of multiple time-frequency resources in accordance with the output configuration.

In some examples of the method, apparatuses, and non-transitory computer-readable medium described herein, outputting the configuration may include operations, features, means, or instructions for outputting, to the UE, an indication of a comb pattern that identifies resource blocks within the assigned set of multiple time-frequency resources to be used at the UE for transmission of the SRS, where the obtained data signal may be rate-matched around the SRS in accordance with the indicated comb pattern.

In some examples of the method, apparatuses, and non-transitory computer-readable medium described herein, outputting, to the UE, an indication to rate-match the data signal around the SRS in accordance with the indicated comb pattern, where obtaining the data signal may be based on the output indication.

In some examples of the method, apparatuses, and non-transitory computer-readable medium described herein, outputting the configuration may include operations, features, means, or instructions for outputting, to the UE, an indication of a comb pattern and frequency offset that identify resources blocks within the assigned set of multiple time-frequency resources to be used at the UE for transmission of the SRS, where the obtained SRS may be multiplexed in accordance with the indicated comb pattern and frequency offset.

In some examples of the method, apparatuses, and non-transitory computer-readable medium described herein, the obtained SRS may be encoded using a first cover code and the obtained data signal may be encoded using a second cover code that may be orthogonal to the first cover code.

Some examples of the method, apparatuses, and non-transitory computer-readable medium described herein may further include operations, features, means, or instructions for obtaining, from the UE, a DMRS, where the obtained DMRS may be multiplexed with the obtained SRS and the obtained data signal across the assigned set of multiple time-frequency resources.

In some examples of the method, apparatuses, and non-transitory computer-readable medium described herein, outputting the configuration may include operations, features, means, or instructions for outputting, to the UE, an indication of resource blocks within the assigned set of multiple time-frequency resources to be used at the UE for transmission of the SRS, where the obtained SRS occupies a first portion of indicated resource blocks and the obtained data signal occupies a second portion of the indicated resource blocks.

Some examples of the method, apparatuses, and non-transitory computer-readable medium described herein may further include operations, features, means, or instructions for estimating a channel for wireless communications between the UE and the network entity based on the obtained SRS, identifying a position of the UE based on the SRS, and sensing an environment associated with the UE based on the obtained SRS.

In some examples of the method, apparatuses, and non-transitory computer-readable medium described herein, sensing the environment associated with the UE may include operations, features, means, or instructions for sensing the environment associated with the UE using multiple input and multiple output (MIMO) radar.

In some examples of the method, apparatuses, and non-transitory computer-readable medium described herein, the data signal includes a PUCCH signal or a PUSCH signal.

A method for wireless communication at a network entity is described. The method may include outputting, to a UE, a configuration for multiplexing a set of multiple reference signals in a Doppler domain, outputting, to the UE, an assignment of a set of multiple time-frequency resources for transmission of the set of multiple reference signals, and obtaining, from the UE, the set of multiple reference signals, where the obtained set of multiple reference signals are multiplexed across the assigned set of multiple time-frequency resources in accordance with the output configuration.

An apparatus for wireless communication at a network entity is described. The apparatus may include a processor, memory coupled with the processor, and instructions stored in the memory. The instructions may be executable by the processor to cause the apparatus to outputting, to a UE, a configuration for multiplex a set of multiple reference signals in a Doppler domain, outputting, to the UE, an assignment of a set of multiple time-frequency resources for transmission of the set of multiple reference signals, and obtain, from the UE, the set of multiple reference signals, where the obtained set of multiple reference signals are multiplexed across the assigned set of multiple time-frequency resources in accordance with the output configuration.

Another apparatus for wireless communication at a network entity is described. The apparatus may include means for outputting, to a UE, a configuration for multiplexing a set of multiple reference signals in a Doppler domain, means for outputting, to the UE, an assignment of a set of multiple time-frequency resources for transmission of the set of multiple reference signals, and means for obtaining, from the UE, the set of multiple reference signals, where the obtained set of multiple reference signals are multiplexed across the assigned set of multiple time-frequency resources in accordance with the output configuration.

A non-transitory computer-readable medium storing code for wireless communication at a network entity is described. The code may include instructions executable by a processor to outputting, to a UE, a configuration for multiplex a set of multiple reference signals in a Doppler domain, outputting, to the UE, an assignment of a set of multiple time-frequency resources for transmission of the set of multiple reference signals, and obtain, from the UE, the set of multiple reference signals, where the obtained set of multiple reference signals are multiplexed across the assigned set of multiple time-frequency resources in accordance with the output configuration.

In some examples of the method, apparatuses, and non-transitory computer-readable medium described herein, outputting, to the UE, an indication of a set of multiple phase codes for multiplexing the set of multiple reference signals, where each obtained reference signal of the obtained set of multiple reference signals may be multiplexed using a respective phase code of the indicated set of multiple phase codes.

In some examples of the method, apparatuses, and non-transitory computer-readable medium described herein, each phase code of the set of multiple phase codes corresponds to a respective antenna port of set of multiple antenna ports at the UE and a respective symbol within the assigned set of multiple time-frequency resources.

Some examples of the method, apparatuses, and non-transitory computer-readable medium described herein may further include operations, features, means, or instructions for estimating a channel for wireless communications between the UE and the network entity, sensing an environment associated with the UE, and identifying a position of the UE.

In some examples of the method, apparatuses, and non-transitory computer-readable medium described herein, the set of multiple reference signals include SRSs, PRSs, or sensing reference signals.

### BRIEF DESCRIPTION OF THE DRAWINGS

FIGS. 1 through 3 each illustrate an example of a wireless communications system that supports techniques for enhanced sounding reference signal (SRS) multiplexing in accordance with various aspects of the present disclosure.

FIGS. 4A and 4B illustrate examples of timing diagrams that supports techniques for enhanced SRS multiplexing in accordance with various aspects of the present disclosure.

FIGS. 5 and 6 each illustrate an example of a process flow that supports techniques for enhanced SRS multiplexing in accordance with various aspects of the present disclosure.

FIGS. 7 and 8 show block diagrams of devices that support techniques for enhanced SRS multiplexing in accordance with various aspects of the present disclosure.

FIG. 9 shows a block diagram of a communications manager that supports techniques for enhanced SRS multiplexing in accordance with various aspects of the present disclosure.

FIG. 10 shows a diagram of a system including a device that supports techniques for enhanced SRS multiplexing in accordance with various aspects of the present disclosure.

FIGS. 11 and 12 show block diagrams of devices that support techniques for enhanced SRS multiplexing in accordance with various aspects of the present disclosure.

FIG. 13 shows a block diagram of a communications manager that supports techniques for enhanced SRS multiplexing in accordance with various aspects of the present disclosure.

FIG. 14 shows a diagram of a system including a device that supports techniques for enhanced SRS multiplexing in accordance with various aspects of the present disclosure.

FIGS. 15 through 18 show flowcharts illustrating methods that support techniques for enhanced SRS multiplexing in accordance with various aspects of the present disclosure.

### DETAILED DESCRIPTION

A wireless multiple-access communications system may include one or more network entities, each simultaneously supporting communication for multiple communication devices, which may be otherwise known as user equipment (UE). For example, a wireless communications system may be configured to support multi-input multi-output (MIMO) at various radio frequency spectrum bands to enable increased throughput within the communications system. In some examples, MIMO communication may be carried out via beamforming using multiple antennas at a transmitting device (e.g., a network entity, a UE) and multiple antennas at a receiving device (e.g., a network entity, a UE). For example, a network entity may apply beamforming to generate a beam in a spatial direction associated with a UE. In some examples of beamforming, the network entity may apply signal processing techniques to select, shape, or steer a directional beam along a spatial path between the network entity and the UE. The spatial path of the generated beam may depend on a set of parameters applied at the network entity. For example, the network entity may determine a set of parameters to use for beamformed communications with the UE based on a channel estimation procedure performed at the network entity using reference signals (e.g., uplink reference signals) transmitted from the UE.

In some examples, however, the UE may be associated with one or more power constraints, which may lead to reduced uplink coverage. For example, power constraints associated with the UE may reduce a distance (e.g., a propagation distance, a transmission range) at which signals transmitted from the UE may propagate while maintaining a suitable power. Additionally, or alternatively, some UEs may become relatively more power constrained for wireless communications using relatively high radio frequency spectrum bands. In some examples, reduced uplink coverage may lead to reduced channel estimation at the network entity. That is, channel estimation performed at the network entity using a reference signal transmitted from a power constrained UE may be reduced irrespective of a quality of a communication channel used for transmission of the reference signal. In some examples, to improve uplink coverage, the UE may increase a duration used for transmission of the reference signal. In such examples, however, using an increased duration for transmission of the reference signal may lead to an increased quantity of time domain resources being used at the UE and, accordingly, increased overhead. Moreover, the UE may be configured to time division multiplex (TDM) reference signals with data signals. In such an example, as the quantity of time domain resources used at the UE for transmission of the reference signal increases, a quantity of time domain resources available for transmission of data signals may decrease, which may lead to reduced throughput within the communication system.

Various aspects of the present disclosure relate to techniques for enhanced sounding reference signal (SRS) multiplexing. For example, to reduce overhead associated with transmission of a reference signal, such as an SRS, the UE may multiplex the reference signal with a data signal in the time domain and the frequency domain. In some examples, the UE may multiplex the reference signal using rate-matching. For example, the UE may rate-match the data signal around the reference signal. Additionally, or alternatively, the UE may multiplex the reference signal using a comb pattern that may be staggered in the frequency domain across multiple time domain resources. For example, the UE may apply a frequency domain offset to the comb pattern, such that the comb pattern may be staggered across the time domain resources. In some examples, the UE may apply orthogonal cover codes to the reference signal and the data signal, such that the UE may transmits the reference signal and the data signal using a same time domain resource. Additionally, or alternatively, the UE may multiplex the reference signal with the data signal and one or more other types of reference signals. In some examples, the UE may use a set of frequency domain resources configured at the UE for transmission of the reference signal for transmission of the reference signal and the data signal.

In some other examples, to reduce overhead associated with transmission of a reference signal the UE may multiplex multiple reference signals in a Doppler-domain. For example, the UE may apply multiple (e.g., different) phase codes to multiple (e.g., different) reference signals transmitted across multiple (e.g., different) antenna ports, such that the UE may use a same time domain resource to transmit multiple reference signals using multiple antenna ports. In such an example, a respective phase code applied to a reference signal may be based on an antenna port used for transmission of the reference signal and the time domain resource during which the reference signal may be transmitted.

Aspects of the subject matter described herein may be implemented to realize one or more potential advantages. For example, the techniques employed by the described communication devices may provide benefits and enhancements to the operation of the communication devices, channel estimation, sensing, and positioning. For example, operations performed by the described communication devices may provide for increased uplink coverage which may lead to improved channel estimation at a network entity. In some implementations, the operations performed by the described communication devices to increase uplink coverage include multiplexing a reference signal with a data signal in a time domain and a frequency domain (e.g., in time and in frequency), or multiplexing multiple reference signals in a Doppler domain, or both. In some other implementations, operations performed by the described communication devices may also support reduced power consumption, increased throughput, and higher data rates, among other benefits.

Aspects of the disclosure are initially described in the context of wireless communications systems. Aspects of the disclosure are also described in the context of timing diagrams and process flows. Aspects of the disclosure are further illustrated by and described with reference to apparatus diagrams, system diagrams, and flowcharts that relate to techniques for enhanced SRS multiplexing.

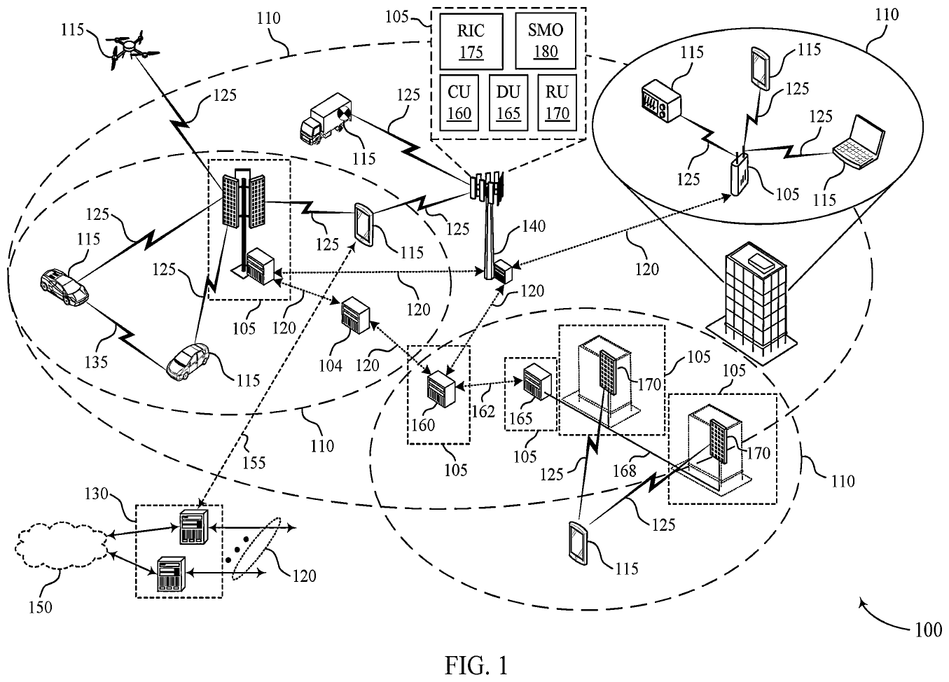

FIG. 1 illustrates an example of a wireless communications system 100 that supports techniques for enhanced SRS multiplexing in accordance with various aspects of the present disclosure. The wireless communications system 100 may include one or more of the network entities 105, one or more of the UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more of the communication links 125 (e.g., a radio frequency access link). For example, a network entity 105 may support a coverage area 110 (e.g., a geographic coverage area) over which the UEs 115 and the network entity 105 may establish one or more of the communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some examples of the UEs 115 are illustrated in FIG. 1. The UEs 115 described herein may be capable of supporting communications with various types of devices, such as other types of the UEs 115 or the network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more of the network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) (e.g., a CU 160), a distributed unit (DU) (e.g., a DU 165), a radio unit (RU) (e.g., an RU 170), a RAN Intelligent Controller (RIC) (e.g., a Near-Real Time RIC (Near-RT RIC), a Non-Real Time RIC (Non-RT RIC)), a Service Management and Orchestration (SMO) (e.g., SMO 180) system, or any combination thereof. For example, the network entity 105 may include one or more of a CU 160, a DU 165, an RU 170, a RIC 175, and an SMO 180. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, radio frequency functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more of the DUs 165 or RUs 170, and one or more of the DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more of the DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., the network entities 105) that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., the IAB nodes 104) may be partially controlled by each other. One or more of the IAB nodes 104 may be referred to as a donor entity or an IAB donor. One or more of the DUs 165 or one or more of the RUs 170 may be partially controlled by one or more of the CUs 160 associated with a donor network entity (e.g., a network entity 105), such as a donor base station (e.g., a base station 140). The one or more donor network entities (e.g., one or more of the network entities 105, IAB donors) may be in communication with an additional one or more of the network entities 105 (e.g., the IAB nodes 104) via supported access and backhaul links (e.g., backhaul communication links 120). The IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., the IAB nodes 104, the UEs 115) within the relay chain or configuration of the access network (e.g., downstream). In such cases, one or more components of the disaggregated RAN architecture (e.g., one or more of the IAB nodes 104 or components of the IAB nodes 104) may be configured to operate according to the techniques described herein.

In the case of the techniques described herein applied in the context of a disaggregated RAN architecture, one or more components of the disaggregated RAN architecture may be configured to support techniques for enhanced SRS multiplexing as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other types of UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more of the communication links 125 (e.g., an access link) using resources associated with one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities of the network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of a radio frequency spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which f max may represent a supported subcarrier spacing, and N f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some examples of the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or radio frequency spectrum band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of TDM techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple of the UEs 115 and UE-specific search space sets for sending control information to a specific (e.g., a UE 115).

In some examples, a network entity 105 (e.g., a base station 140, an RU 170) may be movable and therefore provide communication coverage for a moving coverage area (e.g., a coverage area 110). In some examples, different coverage areas (e.g., coverage areas 110) associated with different technologies may overlap, but the different coverage areas may be supported by the same network entity (e.g., a network entity 105). In some other examples, the overlapping coverage areas (e.g., the coverage areas 110 that may be overlapping) associated with different technologies may be supported by different network entities of the network entities 105. The wireless communications system 100 may include, for example, a heterogeneous network in which different types of the network entities 105 provide coverage for various of the coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or commercial applications. The terms ultra-reliable, low-latency, and ultra-reliable low-latency may be used interchangeably herein.

In some examples, a UE 115 may be configured to support communicating directly with other of the UEs 115 via a device-to-device (D2D) communication link 135 (e.g., in accordance with a peer-to-peer (P2P), D2D, or sidelink protocol). In some examples, one or more of the UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more of the UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs (e.g., the UEs 115) in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more radio frequency spectrum bands, which may be in the range of 300 megahertz (MHz) to 300 gigahertz (GHz). The region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), unlicensed radio frequency spectrum band radio access technology, or NR technology using an unlicensed radio frequency spectrum band such as the 5 GHz industrial, scientific, and medical (ISM) band. While operating using unlicensed radio frequency spectrum bands, devices such as the network entities 105 and the UEs 115 may employ carrier sensing for collision detection and avoidance. In some examples, operations using unlicensed radio frequency spectrum bands may be based on a carrier aggregation configuration in conjunction with component carriers operating using a licensed radio frequency spectrum band (e.g., LAA). Operations using an unlicensed radio frequency spectrum band may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, MIMO communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support radio frequency beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along some orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a receiving device, may be transmitted by transmitting device (e.g., a transmitting network entity, a transmitting UE) along a single beam direction (e.g., a direction associated with the receiving device, such as a receiving network entity or a receiving UE). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support a framework for multiplexing reference signals. For example, a UE 115 may receive a configuration from a network entity 105 for multiplexing an SRS with a data signal in a time domain and a frequency domain (e.g., in time and in frequency). In such an example, the UE 115 may receive an assignment of multiple time-frequency resources from the network entity 105 for transmission of the SRS. In response, the UE 115 may multiplex the SRS with the data signal across the assigned time-frequency resources in accordance with the received configuration and transmit the multiplexed SRS to the network entity.

In some other examples, the UE 115 may receive a configuration from the network entity 105 for multiplexing multiple reference signals in a Doppler domain. In such examples, the UE 115 may receive an assignment of multiple time-frequency resources for transmission of the multiple reference signals. In response, the UE 115 may multiplex the multiple reference signals across the assigned time-frequency resources in accordance with the received configuration and transmit the multiplexed reference signals to the network entity 105.

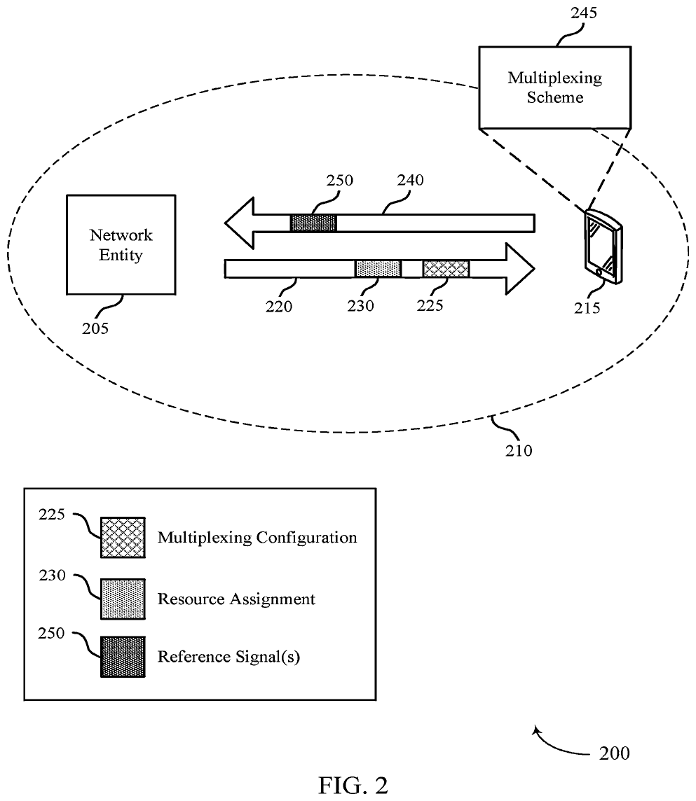

FIG. 2 illustrates an example of a wireless communications system 200 that supports techniques for enhanced SRS multiplexing in accordance with various aspects of the present disclosure. In some examples, the wireless communications system 200 may implement or be implemented at one or more aspects of the wireless communications system 100. For example, the wireless communications system 200 may include a UE 215, which may be an example of a UE 115 as described with reference to FIG. 1. The wireless communications system 200 may also include a network entity 205, which may be an example of one or more of the network entities 105 (e.g., a CU, a DU, an RU, a base station, an IAB node, or one or more other network nodes) as described with reference to FIG. 1. The network entity 205 and the UE 215 may communicate using a downlink 220 and an uplink 240, which may each be an example of a communication link 125 as described with reference to FIG. 1. In the example of FIG. 2, the UE 215 and the network entity 205 may communicate within a coverage area 210, which may be an example of a coverage area 110 as described with reference to FIG. 1. The wireless communications system 200 may include features for improved communications between the network entity 205 and the UE 215, among other possible benefits.

In some examples of the wireless communications system 200 (e.g., a cellular system), uplink communication may constrain coverage (e.g., may be a bottom line for coverage), for example due to power constraints associated with the UE 215. Additionally, or alternatively, the UE 215 may become relatively more power constrained to support relatively high-band operations, which may occur in some deployments (e.g., sixth generation (6G) deployments). For such scenarios, the UE 215 may determine to enhance a quality of reference signals (e.g., an SRS sounding quality) to achieve relatively high throughput communications. For example, the network entity 205 may use (e.g., rely on) channel estimation using SRSs (e.g., transmitted from the UE 215) to achieve relatively high uplink or downlink throughput using MIMO (e.g., massive MIMO) beamforming. In some examples, however, channel estimation at the network entity 205 using the SRSs may be reduced if a quality of the SRSs is relatively poor due to power constraints associated with the UE 215. In some examples, to improve uplink coverage, the UE 215 may transmit an SRS over an increased (e.g., relatively long) time duration. In such examples, however, SRS transmission using the increased time duration may lead to increased consumption of uplink resources (e.g., time-frequency resources allocated for uplink transmissions). Additionally, or alternatively, for some cellular systems (e.g., NR systems), the UE 215 may use TDM to multiplex SRS and data channels or control channels. Additionally, or alternatively, the UE 215 and the network entity 205 may lack a mechanism for non-transparent multiplexing. That is, from the UE 215 perspective and the network entity 205 perspective, the cellular system may fail to support a design to enable non-transparent multiplexing.

In some examples, techniques for enhanced SRS multiplexing, as described herein, may support some designs to enhance the SRS multiplexing. As illustrated in the example of FIG. 2, the UE 215 may receive a multiplexing configuration 225 from the network entity 205. In some examples, the multiplexing configuration 225 may correspond to a configuration for multiplexing a reference signal 250 with a data signal in a time domain and a frequency domain (e.g., in time and in frequency). In such examples, the UE 215 may receive a resource assignment 230 of multiple time-frequency resources for transmission of the reference signal 250. In response, the UE 215 may use a multiplexing scheme 245 to multiplex the reference signal 250 with the data signal across the assigned time-frequency resources in accordance with the received configuration. Additionally, or alternatively, the UE 215 may transmit the multiplexed reference signal (e.g., the reference signal 250) to the network entity 205.

In some other examples, the multiplexing configuration 225 may correspond to a configuration for multiplexing multiple of the reference signals 250 in a Doppler domain. In such examples the UE 215 may receive the resource assignment 230, which may indicate an assignment of multiple time-frequency resources for transmission of the reference signals 250. The UE 215 may use the multiplexing scheme 245 to multiplex the reference signals 250 across the assigned time-frequency resources in accordance with the received configuration. Additionally, or alternatively, the UE 215 may transmit the multiplexed reference signals (e.g., the reference signals 250) to the network entity 205. In some examples, the reference signals 250 may include one or more SRSs, positioning reference signals, or sensing reference signals. As such, the network entity 205 may use the one or more received reference signals for channel sounding (e.g., channel estimation, estimating one or more characteristics associated with a communication channel used for communications between the UE 215 and the network entity 205), identifying a position of the UE 215, or for radar sensing (e.g., MIMO radar sensing, sensing an environment associated with (e.g., surrounding) the UE 215 or the network entity 205). In some examples, multiplexing one or more of the reference signal 250 in accordance with the multiplexing configuration 225 may lead to increased uplink coverage, among other possible benefits.

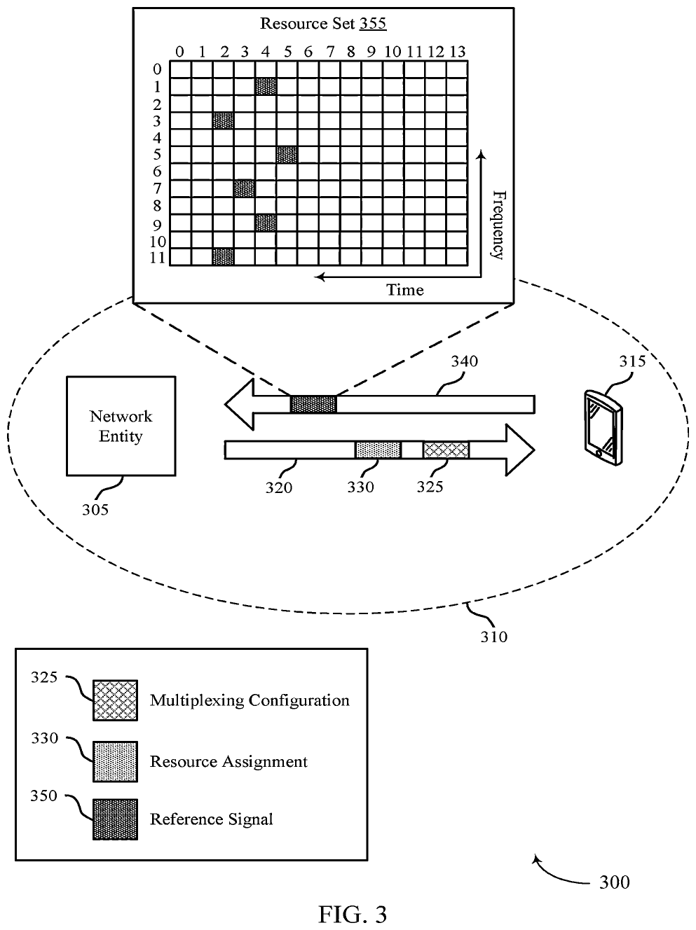

FIG. 3 illustrates an example of a wireless communications system 300 that supports techniques for enhanced SRS multiplexing in accordance with various aspects of the present disclosure. In some examples, the wireless communications system 300 may implement or be implemented at one or more aspects of the wireless communications system 100 and the wireless communications system 200. For example, the wireless communications system 300 may include a UE 315, which may be an example of a UE as described with reference to FIGS. 1 and 2. The wireless communications system 300 may also include a network entity 305, which may be an example of one or more of the network entities (e.g., a CU, a DU, an RU, a base station, an IAB node, or one or more other network nodes) as described with reference to FIGS. 1 and 2. The network entity 305 and the UE 315 may communicate using a downlink 320 and an uplink 340, which may each be an example of a communication link as described with reference to FIGS. 1 and 2. In the example of FIG. 3, the UE 315 and the network entity 305 may communicate within a coverage area 310, which may be an example of a coverage area as described with reference to FIGS. 1 and 2. The wireless communications system 300 may include features for improved communications between the network entity 305 and the UE 315, among other possible benefits.

In some examples, the wireless communications system 300 may be an example of an NR system. In such examples, SRS and data channels or control channels may be TDM multiplexed (e.g., from the UE 315 perspective and the network entity 305 perspective, the wireless communications system 300 may fail to support a design to enable non-transparent multiplexing). In such an example, as a quantity of time domain resources used at the UE 315 for transmission of one or more SRSs increases, a quantity of time domain resources available for transmission of data channels or control channels (e.g., signals transmitted using the data channels or control channels) may decrease, which may lead to reduced throughput within the wireless communications system 300. Additionally, or alternatively, in such examples, the wireless communications system 300 may support use of comb patterns (e.g., comb-2 and comb-4 comb patterns) for transmission of some SRSs (e.g., SRSs for operations other than positioning) without multi-symbol staggering. That is, the wireless communications system 300 may support transmission of the SRS using a comb pattern without staggering the comb pattern across multiple time domain resources. For example, the UE 315 may transmit an SRS in which the SRS occupies 1, 2, or 4 consecutive symbols in a slot, which may be within a relatively last 6 symbols of the slot. In such an example, if more than one antenna port are used for transmission of an SRS in a same OFDM symbol, the SRSs may be on a same comb offset and use cyclic shifts (e.g., equally spaced cyclic shifts). In some examples, the separation may depend on the quantity of antenna ports. Although slots and symbols are referred to throughout the disclosure, it should be understood that the techniques described herein may also apply to other types of time domain resources, which may include other time durations.

In some examples, techniques for enhanced SRS multiplexing, as described herein, may provide for reduced overhead associated with transmission of SRSs at the UE 315 and increased channel estimation at the network entity 305 using the SRSs. For example, such techniques may enable data channel (e.g., physical uplink shared channel (PUSCH)) and control channel (e.g., physical uplink control channel (PUCCH)) rate-matching around SRSs. That is, some techniques for enhanced SRS multiplexing, as described herein, may enable the UE 315 to rate-match signals transmitted using the PUSCH (e.g., PUSCH signals) or signals transmitted using the PUCCH (e.g., PUCCH signals) around an SRS, such that the PUSCH signals or the PUCCH signals and SRS may be multiplexed in the frequency domain (e.g., and the time domain).

As illustrated in the example of FIG. 3, the UE 315 may receive a multiplexing configuration 325 from the network entity 305. In some examples, the multiplexing configuration 325 may correspond to a configuration for multiplexing a reference signal 350 with a data signal in a time domain and a frequency domain. In such examples, the UE 315 may receive a resource assignment 330 of multiple time-frequency resources for transmission of the reference signal 350. In some examples, the multiplexing configuration (or another configuration received from the network entity 305) may indicate for the UE 315 to rate-match the data signal around the reference signal 350. In response, the UE 315 may rate-match the data signal around the reference signal. The UE 315 may multiplex the reference signal 350 with the rate-matched data signal across the assigned time-frequency resources in accordance with the received configuration. Additionally, or alternatively, the UE 315 may transmit the multiplexed reference signal (e.g., the reference signal 350) to the network entity 305.

In some examples, the UE 315 may rate-match the PUSCH signals or the PUCCH signals around an SRS transmitted according to a comb pattern (e.g., a COMB-X SRS pattern). For example, the UE 315 may rate-match PUSCH signals or PUCCH signals that may be OFDM around the SRS transmitted according to a comb pattern.

Additionally, or alternatively, in some other examples, the UE 315 may rate-match PUSCH signals or PUCCH signals that may be DFT-s-OFDM around the SRS transmitted according to a comb pattern. In such examples, the PUSCH or the PUCCH and SRS may be multiplex in the frequency domain (e.g., and the time domain). That is, the UE 315 may FDM the PUSCH or the PUCCH and the SRS using rate-matching. In some examples, the PUSCH signals or the PUCCH signals may occupy a portion of the resources included in the comb pattern. For example, the PUSCH signals or the PUCCH signals may occupy a portion (e.g., 1/X) resources of a COMB-X SRS pattern.

In some examples, the UE 315 may transmit the SRS according to a relatively large comb pattern (e.g., a relatively large comb size). For example, the UE 315 may use a relatively large comb size SRS (e.g., comb-8) to reduce overhead at the UE 315. In some examples, however, a relatively large comb size may impact (e.g., negatively impact) a delay spread resolution associated with the SRS. In such an example, the UE 315 may use multi-symbol time domain staggering. For example, the UE 315 may map the reference signal 350 (e.g., an SRS) to a resource set 355, which may include time domain resources (e.g., symbols) indexed from 0 to 13 and frequency domain resources (e.g., subcarriers) indexed from 0 to 11. As illustrated in the example of FIG. 3, the SRS comb size may correspond to comb-8. For example, the UE 315 may map the reference signal 350 (e.g., SRSs) to the resource set 355 according to a comb-8 comb pattern with 4 symbols (e.g., across symbol indices 2 through 5). That is, the UE 315 may map the reference signal 350 across 4 symbols of the resource set 355 with a periodicity of about 8 subcarriers (e.g., a spacing of about 7 subcarriers) in the frequency domain. Additionally, or alternatively, the UE 315 may apply an offset in the frequency domain, such that frequency domain resources (e.g., subcarriers) occupied with the SRS may change (e.g., may be different) across the time domain resources. For example, the SRS may occupy resource elements with subcarrier indices 3 and 11 and symbol index 2, subcarriers index 7 and symbol index 3, subcarrier indices 1 and 9 and symbol index 4, and subcarrier index 5 and symbol index 5.

In such examples, the network entity 305 may combine symbols in which the SRS may be mapped. For example, the network entity 305 may combine, in the time domain, resource elements with symbol indices 2 through 4. In such an example, after combining the 4 symbols (e.g., after de-staggering), the comb pattern may correspond to (e.g., be equivalent to) a comb-2 comb pattern. That is, the SRS may correspond to a comb-2 SRS. In some other examples, the network entity 305 may combine portions of the resource elements with symbol indices 2 through 4 in the time domain. For example, the network entity 305 may combine time domain resources with symbol indices 2 and 3 or time domain resources with symbol indices 4 and 5. In such an example, after combining the symbol indices 2 and 3 or symbol indices 4 and 5 (e.g., after de-staggering), the comb pattern may correspond to (e.g., be equivalent to) a comb-4 comb pattern. That is, the SRS may correspond to a comb-4 SRS. In some examples, the network entity 305 may use the reference signal 350 for channel estimation, positioning, or sensing. In some examples, the network entity 305 and the UE 315 may support multi-symbol time domain staggering of SRS for positioning across multiple ports, using frequency hopping, and with closed and open loop power control. Additionally, or alternatively, the UE 315 and the network entity 305 may support multi-symbol time domain staggering of SRS for positioning in which symbols occupied by the SRS for positioning may overlap with (e.g., collide with) symbols occupied by PUSCH signals or PUCCH signals.

Additionally, or alternatively, the UE 315 may apply orthogonal cover codes to the SRS and data channels or control channels occupying a same resource to reduce SRS overhead. For example, using the same resource and across multiple (e.g., adjacent) symbols, the UE may apply a first cover code (e.g., a Walsh cover of {+1, +1, +1, +1}) to the SRS and a second cover code (e.g., a Walsh code of {+1, −1, +1, −1}) to the data signal or the control signal, such that the data signal or control signal and SRS may be orthogonal. In such an example, one or more other cover codes (e.g., other Walsh codes) may be assigned to other data or SRS users, for example to multiplex signals from multiple users.

In some examples, the UE 315 may transmit multiple SRS repetitions, such that the network entity 305 may apply interference cancelation based on the SRS repetitions. For example, an SRS for sounding may be repeated over a duration and, as such, may be estimated or measured (e.g., at the network entity 305) across the duration (e.g., using some quantity of symbols). In some examples, subsequent to performing channel estimation using the SRS (e.g., after an SRS channel estimate is derived), the network entity 305 may use the SRS channel estimate to perform interference cancelation of the of SRS on other symbols, for example symbols in which the SRS may be overlapping with (e.g., overlaid with) PUSCH signals or PUCCH signals. In some examples, the UE 315 may multiplex the SRS with a demodulation reference signal (DMRS), for example to orthogonalize the SRS among multiple (e.g., different) users.

In some examples, the UE 315 (e.g., an SRS sounding user) may transmit (e.g., carry) some data, such as PUCCH data (e.g., CSI feedback) using the SRS combs. In such examples, data transmitted from the UE 315 may overlap with or may be non-overlapping with other users (e.g., associated with other UEs). In some examples, the UE 315 may use the SRS resource to carry both the SRS and the data, such as to avoid a throughput associated with each UE (e.g., per UE throughput) being impacted (e.g., handicapped) by channel sounding (e.g., transmission of the SRS). In some examples, multiplexing the SRS with the data (e.g., and DMRS) in the time domain and the frequency domain may lead to increased uplink coverage, among other possible benefits.

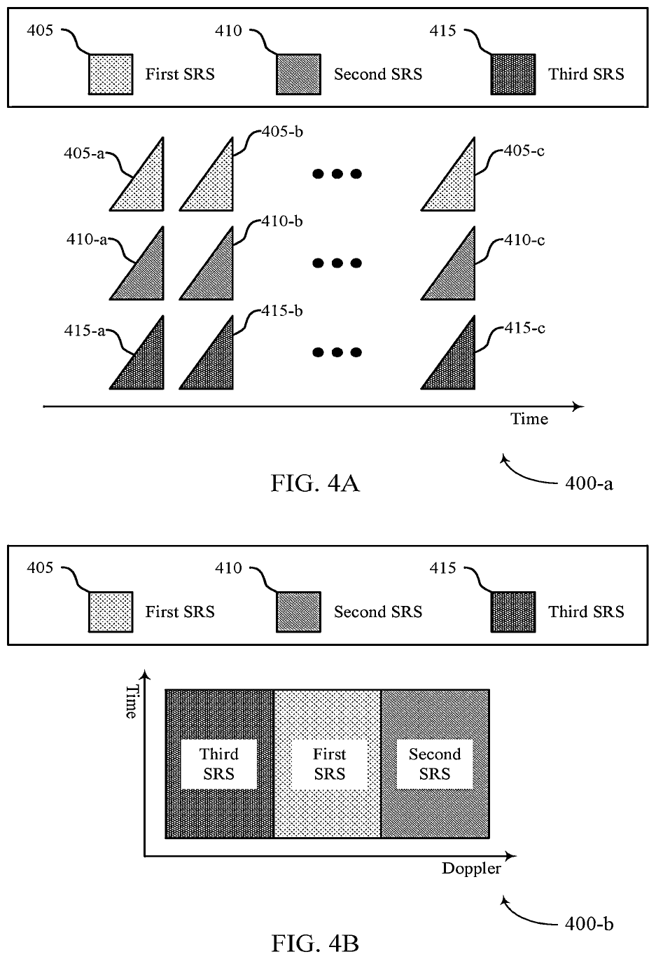

FIGS. 4A and 4B illustrate examples of timing diagrams 400 that supports techniques for enhanced SRS multiplexing in accordance with various aspects of the present disclosure. In some examples, the timing diagrams 400 (e.g., a timing diagram 400-a and a timing diagram 400-b) may be implemented at one or more aspects of the wireless communications system 100, the wireless communications system 200, and the wireless communications system 300. For example, the timing diagrams 400 may be implemented at a UE, which may be an example of a UE as described with reference to FIGS. 1 through 3. The timing diagrams 400 may also be implemented at a network entity, which may be an example of one or more network entities (e.g., a CU, a DU, an RU, a base station, an IAB node, or one or more other network nodes) as described with reference to FIGS. 1 through 3. The timing diagrams 400 may support features for improved communications between the network entity and the UE, among other possible benefits.

In some examples, such as for NR systems, more than one antenna port may be used for transmission of an SRS using a same symbol (e.g., a same OFDM symbol). In such examples, the SRS may use a same comb offset and may be separated (e.g., equally separated) using cyclic shifts. In some examples, the separation may depend on a quantity of antenna ports used at the UE.

In some other examples, to reduce (or further reduce) SRS overhead, multiple (e.g., different) SRSs may occupy a same resource, while maintaining orthogonality via Doppler-division multiplexing (DDM). For example, the UE may use a DDM scheme for (e.g., to achieve) SRS orthogonality. In some examples, the UE may achieve SRS orthogonality via DDM with slow time phase coding. For example, the UE may transmit multiple SRS symbols using multiple (e.g., different) phase codes applied across multiple (e.g., different) SRS antenna ports. That is, the UE may transmit multiple sets of one or more SRSs, in which each set of SRSs may be transmitted using one or more respective antenna ports. In such an example, the UE may use a respective phase code for each SRS included in each set of SRSs.

As illustrated in the example of FIG. 4A, the UE may transmit one or more of the first SRSs 405 using one or more first antenna ports. For example, the UE may use a first antenna port to transmit a first SRS 405-a, a first SRS 405-b, and a first SRS 405-c. In such an example, each of the first SRS 405-a, the first SRS 405-b, and the first SRS 405-c may be transmitted using a respective symbol. Additionally, or alternatively, the UE may transmit one or more of the second SRSs 410 using one or more second antenna ports. For example, the UE may use a second antenna port to transmit a second SRS 410-a, a second SRS 410-b, and a second SRS 410-c. In such an example, each of the second SRS 410-a, the second SRS 410-b, and the second SRS 410-c may be transmitted using a respective symbol. In some examples, the UE may transmit one or more of the third SRSs 415 using one or more third antenna ports. For example, the UE may use a third antenna port to transmit a third SRS 415-a, a third SRS 415-b, and a third SRS 415-c. In such an example, each of the third SRS 415-a, a third SRS 415-b, and a third SRS 415-c may be transmitted using a respective symbol.

In some examples, an SRS from each of the multiple sets of SRSs may be transmitted using a same symbol (e.g., and different antenna ports). For example, the first SRS 405-a, the second SRS 410-a, and the third SRS 415-a may each be transmitted using a first symbol. Additionally, or alternatively, the first SRS 405-b, the second SRS 410-b, and the third SRS 415-b may each be transmitted using a second symbol and the first SRS 405-c, the second SRS 410-c, and the third SRS 415-c may each be transmitted using a third symbol. That is, as illustrated in the example of FIG. 4B, the UE may transmit multiple SRSs (e.g., the first SRSs 405, the second SRSs 410, and the third SRSs 415), such that the multiple SRSs may be overlapping in a time domain and non-overlapping in the Doppler domain.

In some examples, the SRSs may be transmitted across the first, second, and third symbols sequentially. For example, the UE may transmit a quantity (N) of SRS symbols sequentially and each SRS symbol may be multiplied with a respective phase code. In some examples, the respective phase code multiplied with each SRS (e.g., each SRS symbol) may be different for each SRS antenna port. That is, the UE may use multiple (e.g., different) phase codes across multiple (e.g., different) antenna ports. For example, the UE may use multiple (e.g., different) phase codes to transmit the first SRS 405-a, the second SRSs 410, and the third SRSs 415 across multiple antenna ports. Additionally, or alternatively, the UE may use multiple (e.g., different) phase codes to transmit multiple of the first SRSs 405 (or multiple of the second SRSs 410, or multiple of the third SRSs 415) across multiple symbols.

For example, the UE may multiply a waveform of each SRS (e.g., each of the first SRSs 405, each of the second SRSs 410, and each of the third SRSs 415) with a respective phase code that may be determined at the UE in accordance with the following Equation 1:

xₘ(n)=e^{j2πα}^{ₘ}⁽ⁿ⁾ (1)

in which the parameter M may correspond to a respective index associated with a quantity (Mₜ) of SRSs (e.g., M=1, 2, . . . , Mₜ and the parameter n may correspond to a respective index associated with the quantity (N) of symbols used to transmit the SRSs (e.g., n=1, 2, . . . , N). In some examples, to separate the h^{th} SRS at the receiver, a slow-time Doppler demodulation may be applied to each (e.g., all) range bins corresponding to a same SRS.

In some examples, antenna ports used for transmission of the SRS may be coded with a phase that may be determined in accordance with the following Equation 2:

$${w}_{k} = \frac{2 π ( k - 1 )}{{M}_{t}} \qquad ( 2 )$$

in which each antenna port may be mapped to M t Doppler sub-bands. In some examples, techniques for DDM, as described herein, may be used for multiplexing SRSs, positioning reference signals, and sensing reference signals, among other examples. Additionally, or alternatively, techniques for DDM, as described herein, may support increased uplink coverage, among other possible benefits.

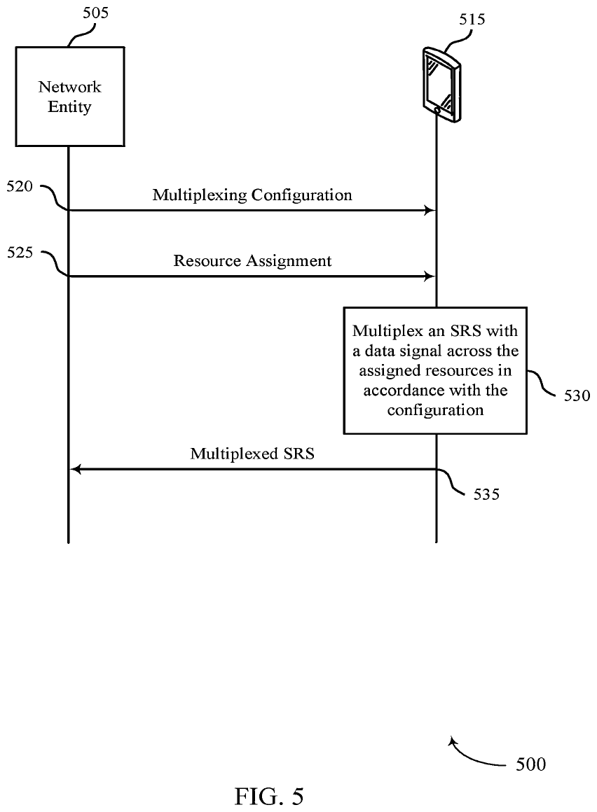

FIG. 5 illustrates an example of a process flow 500 that supports techniques for enhanced SRS multiplexing in accordance with various aspects of the present disclosure. In some examples, the process flow 500 may implement one or more aspects of wireless communications system 100, the wireless communications system 200, the wireless communications system 300, and the timing diagrams 400. For example, the process flow 500 may include example operations associated a network entity 505 and a UE 515, which may be examples of the corresponding devices described with reference to FIGS. 1 through 3, 4A, and 4B. The operations performed by the network entity 505 and the UE 515 may support improvements to communications between the UE 515 and the network entity 505, among other benefits. In the following description of the process flow 500, the operations between the UE 515 and the network entity 505 may occur in a different order than the example order shown. Additionally, or alternatively, the operations performed by the UE 515 and the network entity 505 may be performed in different orders or at different times. Some operations may also be omitted.

At 520, the UE 515 may receive a multiplexing configuration from the network entity 505. The multiplexing configuration may be an example of a multiplexing configuration as described throughout the present disclosure, including with reference to FIGS. 2 and 3. For example, the multiplexing configuration may correspond to a configuration for multiplexing a reference signal (e.g., an SRS) with a data signal in time domain and in frequency.

At 525, the UE 515 may receive a resource assignment of multiple time-frequency resources for transmission of the SRS. The resource assignment may be an example of a resource assignment as described throughout the present disclosure, including with reference to FIG. 2. For example, the UE 515 may use a comb pattern or offset (or both) to identify resource blocks within the multiple time-frequency resources to use for transmission of the SRS.

At 530, the UE 515 may multiplex the SRS with the data signal across the assigned resources (e.g., time-frequency resources) in accordance with the received configuration. In some examples, the UE 515 may rate-match the data signal around the SRS and multiplex the SRS with the rate-matched data signal (e.g., across the assigned time-frequency resources). Additionally, or alternatively, the UE 515 may encode the SRS using a first cover code (e.g., a first Walsh cover code) and encode the data signal using a second cover code (e.g., a second Walsh cover code) that may be orthogonal to the first cover code.

At 535, the UE 515 may transmit the multiplexed SRS to the network entity 505. For example, the UE 515 may transmit the multiplex SRS, such that the network entity 505 may estimate a channel for wireless communications between the UE 515 and the network entity 505, sense an environment associated with the UE 515 (or the network entity 505), or identify a position of the UE 515. In some examples, transmitting the multiplex SRS to the network entity 505 may lead to improved channel estimation, sensing (e.g., radar sense, such as MIMO radar sensing), and positioning at the network entity 505, among other possible benefits.

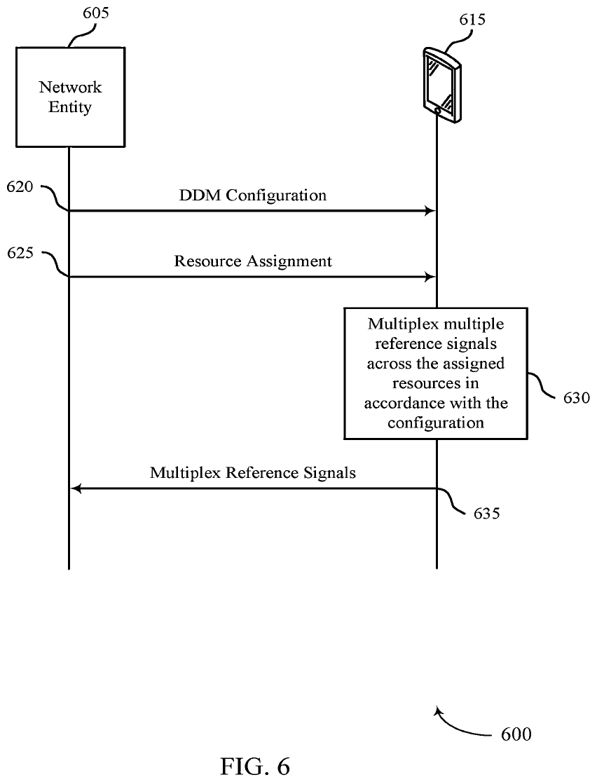

FIG. 6 illustrates an example of a process flow 600 that supports techniques for enhanced SRS multiplexing in accordance with various aspects of the present disclosure. In some examples, the process flow 600 may implement one or more aspects of wireless communications system 100, the wireless communications system 200, the wireless communications system 300, the timing diagrams 400, and the process flow 500. For example, the process flow 600 may include example operations associated a network entity 605 and a UE 615, which may be examples of the corresponding devices described with reference to FIGS. 1 through 3, 4A, 4B, and 5. The operations performed by the network entity 605 and the UE 615 may support improvements to communications between the UE 615 and the network entity 605, among other benefits. In the following description of the process flow 600, the operations between the UE 615 and the network entity 605 may occur in a different order than the example order shown. Additionally, or alternatively, the operations performed by the UE 615 and the network entity 605 may be performed in different orders or at different times. Some operations may also be omitted.

At 620, the UE 615 may receive a DDM configuration from the network entity 605. The DDM configuration may be an example of a multiplexing configuration as described throughout the present disclosure, including with reference to FIGS. 2, 4A, and 4B. For example, the DDM configuration may correspond to a configuration for multiplexing multiple reference signals in a Doppler domain. In some examples, the DDM configuration may indicate multiple phase codes for multiplexing the multiple reference signals in the Doppler domain.

At 625, the UE 615 may receive the resource assignment from the network entity 605. The resource assignment may be an example of a resource assignment as described throughout the present disclosure including with reference to FIG. 2. For example, the resource assignment may correspond to an assignment of multiple time-frequency resources for transmission of the multiple reference signals.

At 630, the UE 615 multiplex the reference signals across the assigned resources (e.g., time-frequency resources) in accordance with the received configuration. For example, the UE 615 may multiply each reference signal with a respective phase code of the phase codes indicated using the DDM configuration.

At 635, the UE 615 may transmit the multiplexed reference signals to the network entity 605. In some examples, the network entity 605 may use the reference signals transmitted from the UE 615 for channel sounding (e.g., estimating one or more characteristics associated with a communication channel used for communications between the UE 615 and the network entity 605), identifying a position of the UE 615, or for radar sensing (e.g., MIMO radar sensing). In some examples, multiplexing the reference signals in accordance with the DDM configuration may lead to increased uplink coverage, among other possible benefits.

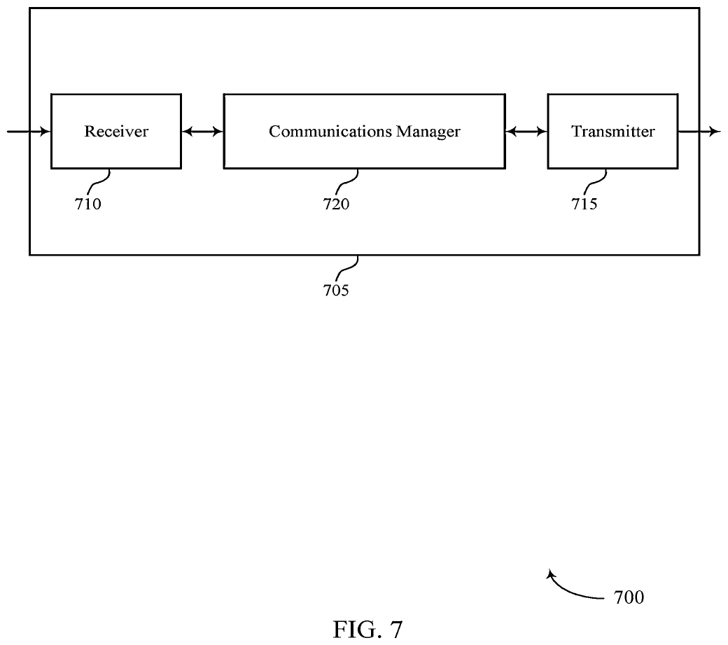

FIG. 7 shows a block diagram 700 of a device 705 that supports techniques for enhanced SRS multiplexing in accordance with various aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for enhanced SRS multiplexing). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for enhanced SRS multiplexing). In some examples, the transmitter 715 may be co-located with a receiver 710 in a transceiver component. The transmitter 715 may utilize a single antenna or a set of multiple antennas.

The communications manager 720, the receiver 710, the transmitter 715, or various combinations thereof or various components thereof may be examples of means for performing various aspects of techniques for enhanced SRS multiplexing as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. For example, the communications manager 720 may be configured as or otherwise support a means for receiving, from a network entity, a configuration for multiplexing an SRS with a data signal in time and in frequency. The communications manager 720 may be configured as or otherwise support a means for receiving, from the network entity, an assignment of a set of multiple time-frequency resources for transmission of the SRS. The communications manager 720 may be configured as or otherwise support a means for multiplexing the SRS with the data signal across the assigned set of multiple time-frequency resources in accordance with the received configuration. The communications manager 720 may be configured as or otherwise support a means for transmitting, to the network entity, the multiplexed SRS.

Additionally, or alternatively, the communications manager 720 may support wireless communication at a UE (e.g., the device 705) in accordance with examples as disclosed herein. For example, the communications manager 720 may be configured as or otherwise support a means for receiving, from a network entity, a configuration for multiplexing a set of multiple reference signals in a Doppler domain. The communications manager 720 may be configured as or otherwise support a means for receiving, from the network entity, an assignment of a set of multiple time-frequency resources for transmission of the set of multiple reference signals. The communications manager 720 may be configured as or otherwise support a means for multiplexing the set of multiple reference signals across the assigned set of multiple time-frequency resources in accordance with the received configuration. The communications manager 720 may be configured as or otherwise support a means for transmitting, to the network entity, the multiplexed set of multiple reference signals.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for more efficient utilization of communication resources.

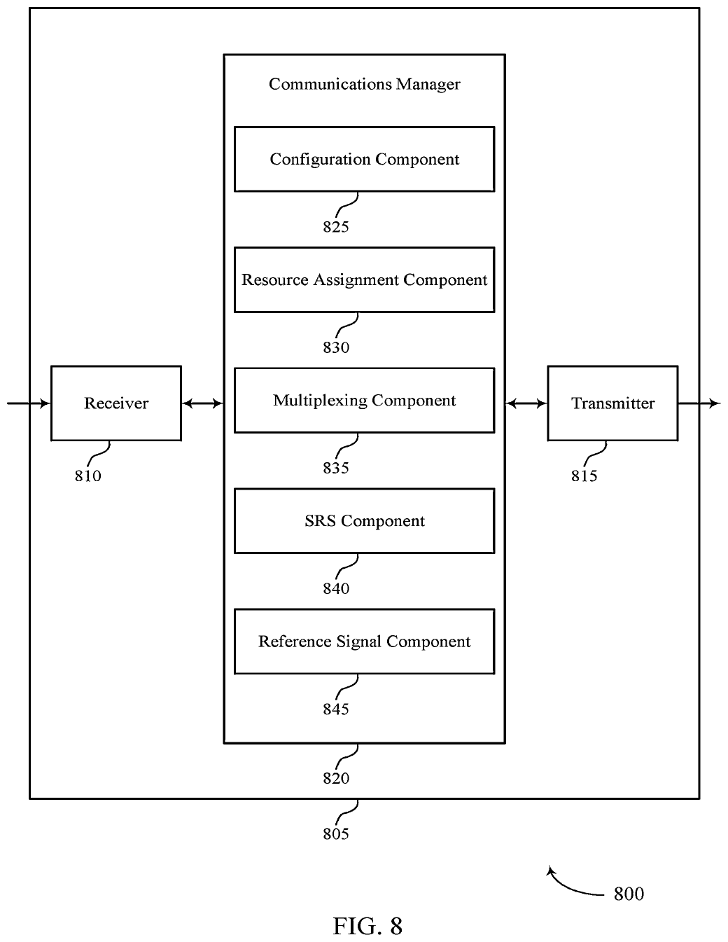

FIG. 8 shows a block diagram 800 of a device 805 that supports techniques for enhanced SRS multiplexing in accordance with various aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for enhanced SRS multiplexing). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for enhanced SRS multiplexing). In some examples, the transmitter 815 may be co-located with a receiver 810 in a transceiver component. The transmitter 815 may utilize a single antenna or a set of multiple antennas.

The device 805, or various components thereof, may be an example of means for performing various aspects of techniques for enhanced SRS multiplexing as described herein. For example, the communications manager 820 may include a configuration component 825, a resource assignment component 830, a multiplexing component 835, an SRS component 840, a reference signal component 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE (e.g., the device 805) in accordance with examples as disclosed herein. The configuration component 825 may be configured as or otherwise support a means for receiving, from a network entity, a configuration for multiplexing an SRS with a data signal in time and in frequency. The resource assignment component 830 may be configured as or otherwise support a means for receiving, from the network entity, an assignment of a set of multiple time-frequency resources for transmission of the SRS. The multiplexing component 835 may be configured as or otherwise support a means for multiplexing the SRS with the data signal across the assigned set of multiple time-frequency resources in accordance with the received configuration. The SRS component 840 may be configured as or otherwise support a means for transmitting, to the network entity, the multiplexed SRS.

Additionally, or alternatively, the communications manager 820 may support wireless communication at a UE (e.g., the device 805) in accordance with examples as disclosed herein. The configuration component 825 may be configured as or otherwise support a means for receiving, from a network entity, a configuration for multiplexing a set of multiple reference signals in a Doppler domain. The resource assignment component 830 may be configured as or otherwise support a means for receiving, from the network entity, an assignment of a set of multiple time-frequency resources for transmission of the set of multiple reference signals. The multiplexing component 835 may be configured as or otherwise support a means for multiplexing the set of multiple reference signals across the assigned set of multiple time-frequency resources in accordance with the received configuration. The reference signal component 845 may be configured as or otherwise support a means for transmitting, to the network entity, the multiplexed set of multiple reference signals.

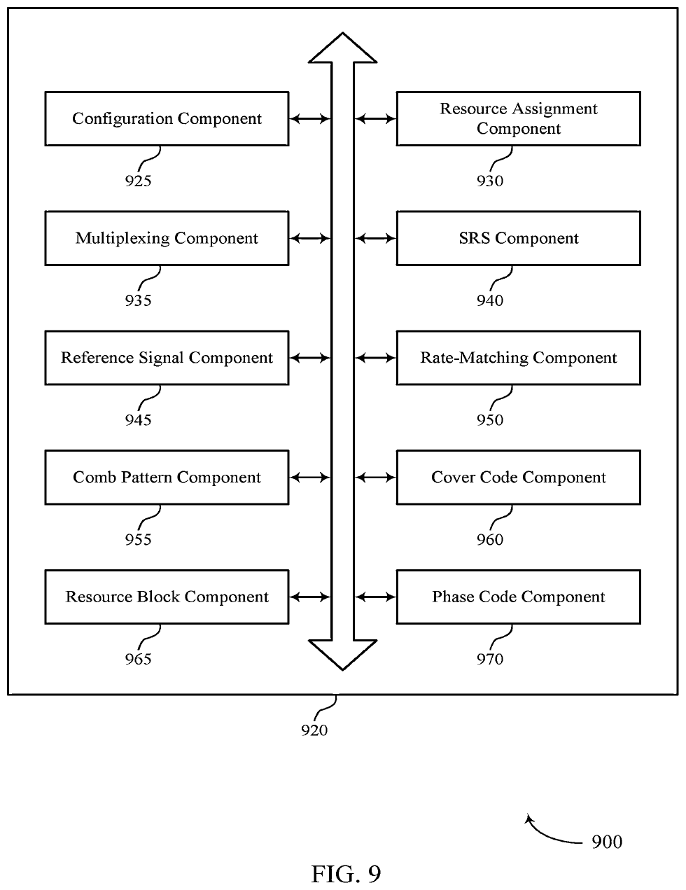

FIG. 9 shows a block diagram 900 of a communications manager 920 that supports techniques for enhanced SRS multiplexing in accordance with various aspects of the present disclosure. The communications manager 920 may be an example of aspects of a communications manager 720, a communications manager 820, or both, as described herein. The communications manager 920, or various components thereof, may be an example of means for performing various aspects of techniques for enhanced SRS multiplexing as described herein. For example, the communications manager 920 may include a configuration component 925, a resource assignment component 930, a multiplexing component 935, an SRS component 940, a reference signal component 945, a rate-matching component 950, a comb pattern component 955, a cover code component 960, a resource block component 965, a phase code component 970, or any combination thereof. Each of these components may communicate, directly or indirectly, with one another (e.g., via one or more buses).

The communications manager 920 may support wireless communication at a UE in accordance with examples as disclosed herein. The configuration component 925 may be configured as or otherwise support a means for receiving, from a network entity, a configuration for multiplexing an SRS with a data signal in time and in frequency. The resource assignment component 930 may be configured as or otherwise support a means for receiving, from the network entity, an assignment of a set of multiple time-frequency resources for transmission of the SRS. The multiplexing component 935 may be configured as or otherwise support a means for multiplexing the SRS with the data signal across the assigned set of multiple time-frequency resources in accordance with the received configuration. The SRS component 940 may be configured as or otherwise support a means for transmitting, to the network entity, the multiplexed SRS.

In some examples, to support multiplexing the SRS with the data signal, the rate-matching component 950 may be configured as or otherwise support a means for receiving, from the network entity, an indication to rate-match the data signal around the SRS. In some examples, to support multiplexing the SRS with the data signal, the rate-matching component 950 may be configured as or otherwise support a means for rate-matching the data signal around the SRS in response to receiving the indication. In some examples, to support multiplexing the SRS with the data signal, the multiplexing component 935 may be configured as or otherwise support a means for multiplexing the SRS with the rate-matched data signal across the assigned set of multiple time-frequency resources.

In some examples, to support rate-matching the data signal around the SRS, the comb pattern component 955 may be configured as or otherwise support a means for receiving, from the network entity, an indication of a comb pattern that identifies resource blocks within the assigned set of multiple time-frequency resources to be used at the UE for transmission of the SRS. In some examples, to support rate-matching the data signal around the SRS, the rate-matching component 950 may be configured as or otherwise support a means for rate-matching the data signal around the SRS across the assigned set of multiple time-frequency resources in accordance with the indicated comb pattern.

In some examples, to support multiplexing the SRS with the data signal, the comb pattern component 955 may be configured as or otherwise support a means for receiving, from the network entity, an indication of a comb pattern and frequency offset associated with the comb pattern that identify resource blocks within the assigned set of multiple time-frequency resources to be used at the UE for transmission of the SRS. In some examples, to support multiplexing the SRS with the data signal, the multiplexing component 935 may be configured as or otherwise support a means for multiplexing the SRS with the data signal across the assigned set of multiple time-frequency resources in accordance with the indicated comb pattern and frequency offset.

In some examples, to support multiplexing the SRS with the data signal, the cover code component 960 may be configured as or otherwise support a means for encoding the SRS using a first cover code. In some examples, to support multiplexing the SRS with the data signal, the cover code component 960 may be configured as or otherwise support a means for encoding the data signal using a second cover code that is orthogonal to the first cover code. In some examples, to support multiplexing the SRS with the data signal, the multiplexing component 935 may be configured as or otherwise support a means for multiplexing the SRS with the data signal across the assigned set of multiple time-frequency resources.

In some examples, to support multiplexing the SRS with the data signal, the multiplexing component 935 may be configured as or otherwise support a means for multiplexing the SRS with the data signal and at least one DMRS across the assigned set of multiple time-frequency resources.

In some examples, to support multiplexing the SRS with the data signal, the resource block component 965 may be configured as or otherwise support a means for receiving, from the network entity, an indication of resource blocks within the assigned set of multiple time-frequency resources to be used at the UE for transmission of the SRS. In some examples, to support multiplexing the SRS with the data signal, the multiplexing component 935 may be configured as or otherwise support a means for multiplexing the SRS with the data signal across the indicated resource blocks within the assigned set of multiple time-frequency resources, where the SRS occupies a first portion of indicated resource blocks and the data signal occupies a second portion of the indicated resource blocks.

In some examples, the SRS component 940 may be configured as or otherwise support a means for the SRS being used for estimating, at the network entity, a channel for wireless communications between the UE and the network entity. In some examples, the SRS component 940 may be configured as or otherwise support a means for the SRS being used for sensing, at the network entity; an environment associated with the UE. In some examples, the SRS component 940 may be configured as or otherwise support a means for the SRS being used for identifying, at the network entity, a position of the UE. In some examples, the data signal includes a PUCCH signal or a PUSCH.

Additionally, or alternatively, the communications manager 920 may support wireless communication at a UE in accordance with examples as disclosed herein. In some examples, the configuration component 925 may be configured as or otherwise support a means for receiving, from a network entity, a configuration for multiplexing a set of multiple reference signals in a Doppler domain. In some examples, the resource assignment component 930 may be configured as or otherwise support a means for receiving, from the network entity, an assignment of a set of multiple time-frequency resources for transmission of the set of multiple reference signals. In some examples, the multiplexing component 935 may be configured as or otherwise support a means for multiplexing the set of multiple reference signals across the assigned set of multiple time-frequency resources in accordance with the received configuration. The reference signal component 945 may be configured as or otherwise support a means for transmitting, to the network entity, the multiplexed set of multiple reference signals.

In some examples, to support multiplexing the set of multiple reference signals, the phase code component 970 may be configured as or otherwise support a means for receiving, from the network entity, an indication of a set of multiple phase codes for multiplexing the set of multiple reference signals in the Doppler domain. In some examples, to support multiplexing the set of multiple reference signals, the multiplexing component 935 may be configured as or otherwise support a means for multiplexing the set of multiple reference signals using the indicated set of multiple phase codes.

In some examples, to support multiplexing the set of multiple reference signals using the indicated set of multiple phase codes, the phase code component 970 may be configured as or otherwise support a means for multiplying each reference signal of the set of multiple reference signals with a respective phase code of the indicated set of multiple phase codes. In some examples, each respective phase code is based on a respective antenna port of set of multiple antenna ports at the UE and a respective symbol within the assigned set of multiple time-frequency resources.

The reference signal component 945 may be configured as or otherwise support a means for the reference signal being used for estimating, at the network entity, a channel for wireless communications between the UE and the network entity. The reference signal component 945 may be configured as or otherwise support a means for the reference signal being used for sensing, at the network entity, an environment associated with the UE. The reference signal component 945 may be configured as or otherwise support a means for the reference signal being used for identifying, at the network entity, a position of the UE. In some examples, the set of multiple reference signals include SRSs, positioning reference signals, or sensing reference signals.

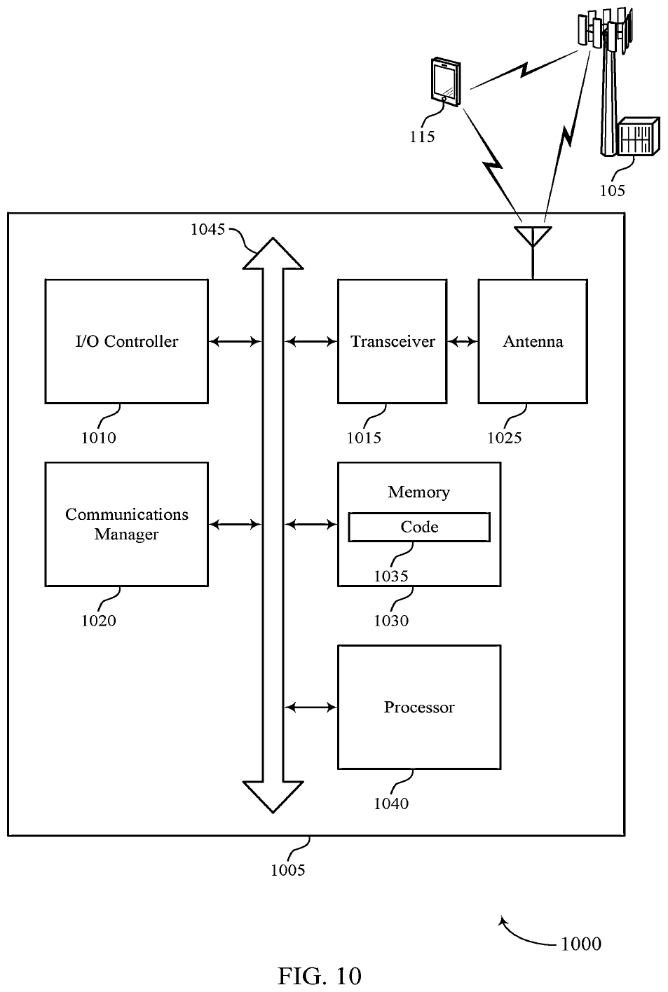

FIG. 10 shows a diagram of a system 1000 including a device 1005 that supports techniques for enhanced SRS multiplexing in accordance with various aspects of the present disclosure. The device 1005 may be an example of or include the components of a device 705, a device 805, or a UE 115 as described herein. The device 1005 may communicate (e.g., wirelessly) with one or more of the network entities 105, one or more of the UEs 115, or any combination thereof. The device 1005 may include components for bi-directional voice and data communications including components for transmitting and receiving communications, such as a communications manager 1020, an input/output (I/O) controller (e.g., an I/O controller 1010), a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna (e.g., an antenna 1025). However, in some other cases, the device 1005 may have more than one of the antenna 1025, which may be capable of concurrently transmitting or receiving multiple wireless transmissions. The transceiver 1015 may communicate bi-directionally, via one or more of the antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more of the antennas 1025 for transmission, and to demodulate packets received from one or more of the antennas 1025. The transceiver 1015, or the transceiver 1015 and one or more of the antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code (e.g., the code 1035) including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for enhanced SRS multiplexing). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE (e.g., the device 1005) in accordance with examples as disclosed herein. For example, the communications manager 1020 may be configured as or otherwise support a means for receiving, from a network entity, a configuration for multiplexing an SRS with a data signal in time and in frequency. The communications manager 1020 may be configured as or otherwise support a means for receiving, from the network entity, an assignment of a set of multiple time-frequency resources for transmission of the SRS. The communications manager 1020 may be configured as or otherwise support a means for multiplexing the SRS with the data signal across the assigned set of multiple time-frequency resources in accordance with the received configuration. The communications manager 1020 may be configured as or otherwise support a means for transmitting, to the network entity, the multiplexed SRS.

Additionally, or alternatively, the communications manager 1020 may support wireless communication at a UE (e.g., the device 1005) in accordance with examples as disclosed herein. For example, the communications manager 1020 may be configured as or otherwise support a means for receiving, from a network entity, a configuration for multiplexing a set of multiple reference signals in a Doppler domain. The communications manager 1020 may be configured as or otherwise support a means for receiving, from the network entity, an assignment of a set of multiple time-frequency resources for transmission of the set of multiple reference signals. The communications manager 1020 may be configured as or otherwise support a means for multiplexing the set of multiple reference signals across the assigned set of multiple time-frequency resources in accordance with the received configuration. The communications manager 1020 may be configured as or otherwise support a means for transmitting, to the network entity, the multiplexed set of multiple reference signals.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, one or more of the antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for enhanced SRS multiplexing as described herein, or the processor 1040 and the memory 1030 may be otherwise configured to perform or support such operations.

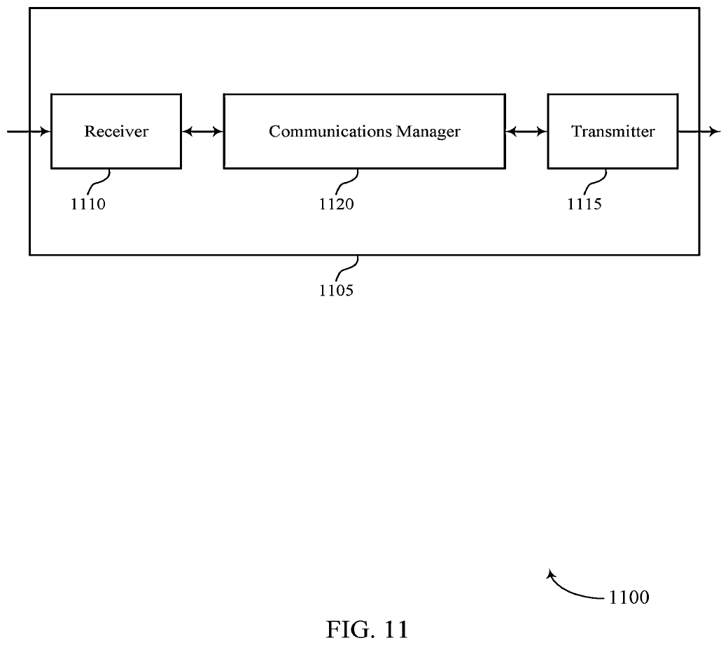

FIG. 11 shows a block diagram 1100 of a device 1105 that supports techniques for enhanced SRS multiplexing in accordance with various aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for enhanced SRS multiplexing as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for outputting, to a UE, a configuration for multiplexing an SRS with a data signal in time and in frequency. The communications manager 1120 may be configured as or otherwise support a means for outputting, to the UE, an assignment of a set of multiple time-frequency resources for transmission of the SRS. The communications manager 1120 may be configured as or otherwise support a means for obtaining, from the UE, the SRS and the data signal, where the obtained SRS is multiplexed with the obtained data signal across the assigned set of multiple time-frequency resources in accordance with the output configuration.

Additionally, or alternatively, the communications manager 1120 may support wireless communication at a network entity (e.g., the device 1105) in accordance with examples as disclosed herein. For example, the communications manager 1120 may be configured as or otherwise support a means for outputting, to a UE, a configuration for multiplexing a set of multiple reference signals in a Doppler domain. The communications manager 1120 may be configured as or otherwise support a means for outputting, to the UE, an assignment of a set of multiple time-frequency resources for transmission of the set of multiple reference signals. The communications manager 1120 may be configured as or otherwise support a means for obtaining, from the UE, the set of multiple reference signals, where the obtained set of multiple reference signals are multiplexed across the assigned set of multiple time-frequency resources in accordance with the output configuration.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for more efficient utilization of communication resources.

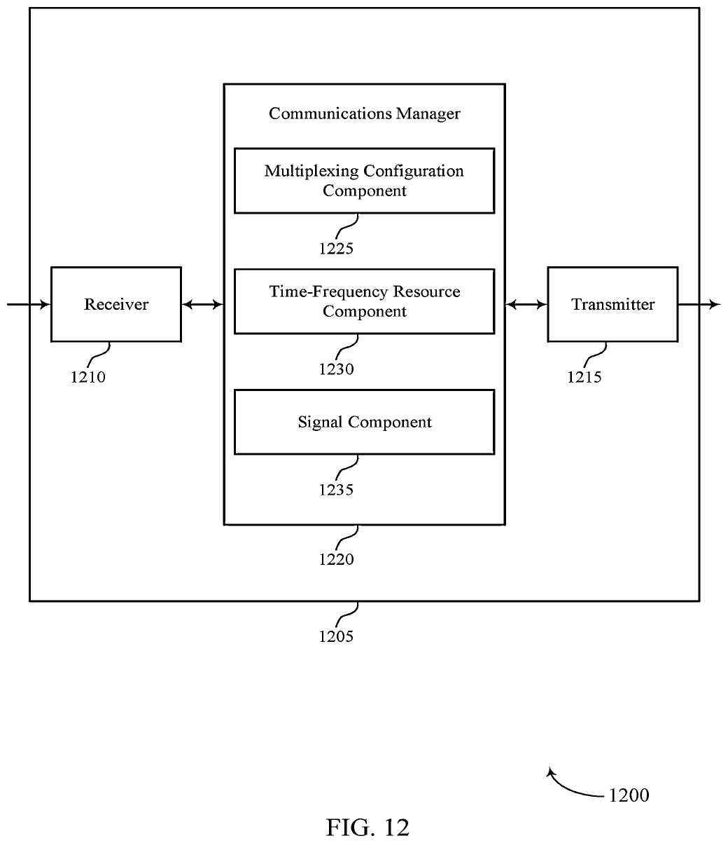

FIG. 12 shows a block diagram 1200 of a device 1205 that supports techniques for enhanced SRS multiplexing in accordance with various aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for enhanced SRS multiplexing as described herein. For example, the communications manager 1220 may include a multiplexing configuration component 1225, a time-frequency resource component 1230, a signal component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The multiplexing configuration component 1225 may be configured as or otherwise support a means for outputting, to a UE, a configuration for multiplexing an SRS with a data signal in time and in frequency. The time-frequency resource component 1230 may be configured as or otherwise support a means for outputting, to the UE, an assignment of a set of multiple time-frequency resources for transmission of the SRS. The signal component 1235 may be configured as or otherwise support a means for obtaining, from the UE, the SRS and the data signal, where the obtained SRS is multiplexed with the obtained data signal across the assigned set of multiple time-frequency resources in accordance with the output configuration.

Additionally, or alternatively, the communications manager 1220 may support wireless communication at a network entity (e.g., the device 1205) in accordance with examples as disclosed herein. The multiplexing configuration component 1225 may be configured as or otherwise support a means for outputting, to a UE, a configuration for multiplexing a set of multiple reference signals in a Doppler domain. The time-frequency resource component 1230 may be configured as or otherwise support a means for outputting, to the UE, an assignment of a set of multiple time-frequency resources for transmission of the set of multiple reference signals. The signal component 1235 may be configured as or otherwise support a means for obtaining, from the UE, the set of multiple reference signals, where the obtained set of multiple reference signals are multiplexed across the assigned set of multiple time-frequency resources in accordance with the output configuration.

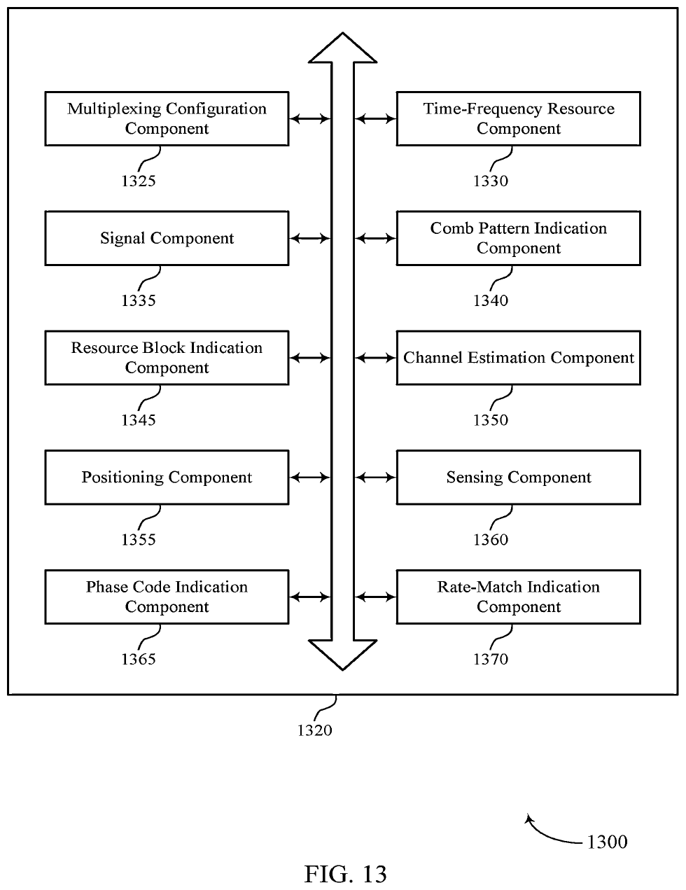

FIG. 13 shows a block diagram 1300 of a communications manager 1320 that supports techniques for enhanced SRS multiplexing in accordance with various aspects of the present disclosure. The communications manager 1320 may be an example of aspects of a communications manager 1120, a communications manager 1220, or both, as described herein. The communications manager 1320, or various components thereof, may be an example of means for performing various aspects of techniques for enhanced SRS multiplexing as described herein. For example, the communications manager 1320 may include a multiplexing configuration component 1325, a time-frequency resource component 1330, a signal component 1335, a comb pattern indication component 1340, a resource block indication component 1345, a channel estimation component 1350, a positioning component 1355, a sensing component 1360, a phase code indication component 1365, a rate-match indication component 1370, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The multiplexing configuration component 1325 may be configured as or otherwise support a means for outputting, to a UE, a configuration for multiplexing an SRS with a data signal in time and in frequency. The time-frequency resource component 1330 may be configured as or otherwise support a means for outputting, to the UE, an assignment of a set of multiple time-frequency resources for transmission of the SRS. The signal component 1335 may be configured as or otherwise support a means for obtaining, from the UE, the SRS and the data signal, where the obtained SRS is multiplexed with the obtained data signal across the assigned set of multiple time-frequency resources in accordance with the output configuration.

In some examples, to support outputting the configuration, the comb pattern indication component 1340 may be configured as or otherwise support a means for outputting, to the UE, an indication of a comb pattern that identifies resource blocks within the assigned set of multiple time-frequency resources to be used at the UE for transmission of the SRS, where the obtained data signal is rate-matched around the SRS in accordance with the indicated comb pattern.

In some examples, the rate-match indication component 1370 may be configured as or otherwise support a means for outputting, to the UE, an indication to rate-match the data signal around the SRS in accordance with the indicated comb pattern, where obtaining the data signal is based on the output indication.

In some examples, to support outputting the configuration, the comb pattern indication component 1340 may be configured as or otherwise support a means for outputting, to the UE, an indication of a comb pattern and frequency offset that identify resources blocks within the assigned set of multiple time-frequency resources to be used at the UE for transmission of the SRS, where the obtained SRS is multiplexed in accordance with the indicated comb pattern and frequency offset. In some examples, the obtained SRS is encoded using a first cover code and the obtained data signal is encoded using a second cover code that is orthogonal to the first cover code.

In some examples, the signal component 1335 may be configured as or otherwise support a means for obtaining, from the UE, a DMRS, where the obtained DMRS is multiplexed with the obtained SRS and the obtained data signal across the assigned set of multiple time-frequency resources.

In some examples, to support outputting the configuration, the resource block indication component 1345 may be configured as or otherwise support a means for outputting, to the UE, an indication of resource blocks within the assigned set of multiple time-frequency resources to be used at the UE for transmission of the SRS, where the obtained SRS occupies a first portion of indicated resource blocks and the obtained data signal occupies a second portion of the indicated resource blocks.

In some examples, the channel estimation component 1350 may be configured as or otherwise support a means for estimating a channel for wireless communications between the UE and the network entity based on the obtained SRS. In some examples, the positioning component 1355 may be configured as or otherwise support a means for identifying a position of the UE based on the SRS. In some examples, the sensing component 1360 may be configured as or otherwise support a means for sensing an environment associated with the UE based on the obtained SRS.

In some examples, to support sensing the environment associated with the UE, the sensing component 1360 may be configured as or otherwise support a means for sensing the environment associated with the UE using MIMO radar. In some examples, the data signal includes a PUCCH signal or a PUSCH.

Additionally, or alternatively, the communications manager 1320 may support wireless communication at a network entity in accordance with examples as disclosed herein. In some examples, the multiplexing configuration component 1325 may be configured as or otherwise support a means for outputting, to a UE, a configuration for multiplexing a set of multiple reference signals in a Doppler domain. In some examples, the time-frequency resource component 1330 may be configured as or otherwise support a means for outputting, to the UE, an assignment of a set of multiple time-frequency resources for transmission of the set of multiple reference signals. In some examples, the signal component 1335 may be configured as or otherwise support a means for obtaining, from the UE, the set of multiple reference signals, where the obtained set of multiple reference signals are multiplexed across the assigned set of multiple time-frequency resources in accordance with the output configuration.

In some examples, the phase code indication component 1365 may be configured as or otherwise support a means for outputting, to the UE, an indication of a set of multiple phase codes for multiplexing the set of multiple reference signals, where each obtained reference signal of the obtained set of multiple reference signals is multiplexed using a respective phase code of the indicated set of multiple phase codes.

In some examples, each phase code of the set of multiple phase codes corresponds to a respective antenna port of set of multiple antenna ports at the UE and a respective symbol within the assigned set of multiple time-frequency resources.

In some examples, the channel estimation component 1350 may be configured as or otherwise support a means for estimating a channel for wireless communications between the UE and the network entity based on the obtained set of multiple reference signals. In some examples, the positioning component 1355 may be configured as or otherwise support a means for identifying a position of the UE based on the obtained set of multiple reference signal. In some examples, the sensing component 1360 may be configured as or otherwise support a means for sensing an environment associated with the UE based on the obtained set of multiple reference signal. In some examples, the set of multiple reference signals include SRSs, positioning reference signals, or sensing reference signals.

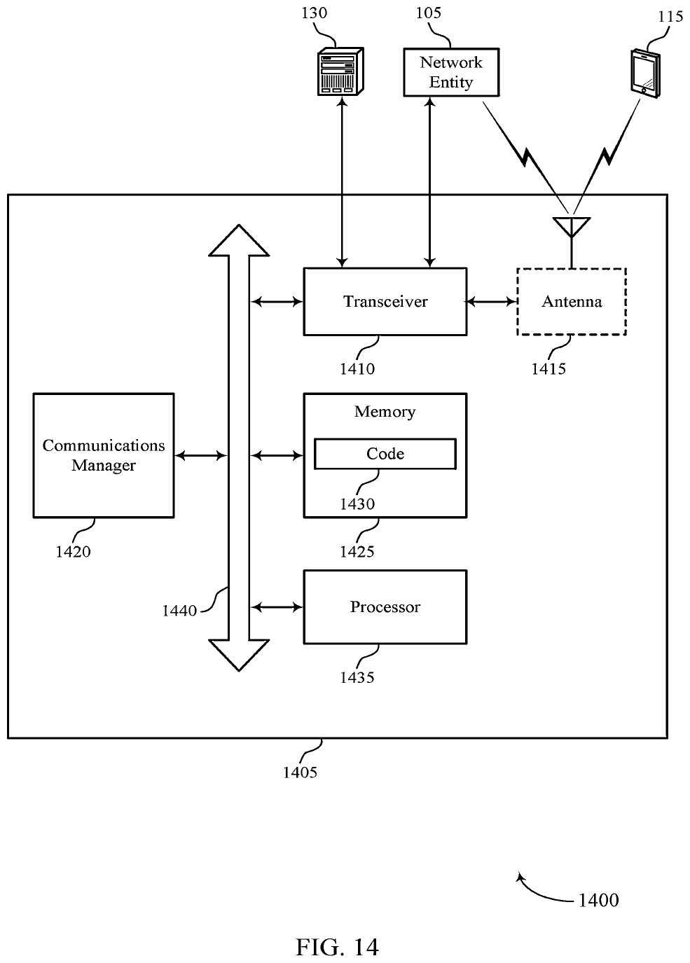

FIG. 14 shows a diagram of a system 1400 including a device 1405 that supports techniques for enhanced SRS multiplexing in accordance with various aspects of the present disclosure. The device 1405 may be an example of or include the components of a device 1105, a device 1205, or a network entity 105 as described herein. The device 1405 may communicate with one or more of the network entities 105, one or more of the UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more of the antennas 1415, which may be capable of transmitting or receiving wireless transmissions (e.g., concurrently). The transceiver 1410 may also include a modem to modulate signals, to provide the modulated signals for transmission (e.g., by one or more of the antennas 1415, by a wired transmitter), to receive modulated signals (e.g., from one or more of the antennas 1415, from a wired receiver), and to demodulate signals. In some implementations, the transceiver 1410 may include one or more interfaces, such as one or more interfaces coupled with one or more of the antennas 1415 that are configured to support various receiving or obtaining operations, or one or more interfaces coupled with one or more of the antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and one or more of the antennas 1415, or the transceiver 1410 and one or more of the antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code (e.g., the code 1430) including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting techniques for enhanced SRS multiplexing). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more of the UEs 115. In some examples, the communications manager 1420 may manage communications with other network entities of the network entities 105, and may include a controller or scheduler for controlling communications with UEs 115 in cooperation with other network entities of the network entities 105. In some examples, the communications manager 1420 may support an X2 interface within an LTE/LTE-A wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for outputting, to a UE, a configuration for multiplexing an SRS with a data signal in time and in frequency. The communications manager 1420 may be configured as or otherwise support a means for outputting, to the UE, an assignment of a set of multiple time-frequency resources for transmission of the SRS. The communications manager 1420 may be configured as or otherwise support a means for obtaining, from the UE, the SRS and the data signal, where the obtained SRS is multiplexed with the obtained data signal across the assigned set of multiple time-frequency resources in accordance with the output configuration.

Additionally, or alternatively, the communications manager 1420 may support wireless communication at a network entity (e.g., the device 1405) in accordance with examples as disclosed herein. For example, the communications manager 1420 may be configured as or otherwise support a means for outputting, to a UE, a configuration for multiplexing a set of multiple reference signals in a Doppler domain. The communications manager 1420 may be configured as or otherwise support a means for outputting, to the UE, an assignment of a set of multiple time-frequency resources for transmission of the set of multiple reference signals. The communications manager 1420 may be configured as or otherwise support a means for obtaining, from the UE, the set of multiple reference signals, where the obtained set of multiple reference signals are multiplexed across the assigned set of multiple time-frequency resources in accordance with the output configuration.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, obtaining, monitoring, outputting, transmitting) using or otherwise in cooperation with the transceiver 1410, one or more of the antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of techniques for enhanced SRS multiplexing as described herein, or the processor 1435 and the memory 1425 may be otherwise configured to perform or support such operations.

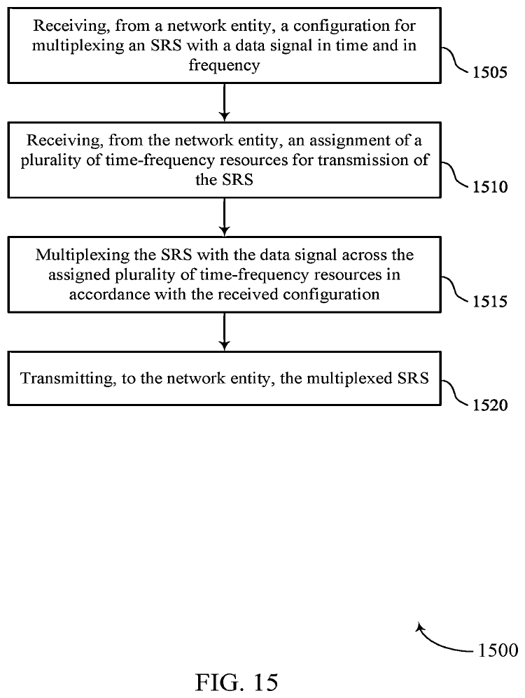

FIG. 15 shows a flowchart illustrating a method 1500 that supports techniques for enhanced SRS multiplexing in accordance with various aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a configuration for multiplexing an SRS with a data signal in time and in frequency. The operations of 1505 may be performed in accordance with examples as disclosed herein. In some examples, aspects of the operations of 1505 may be performed by a configuration component 925 as described with reference to FIG. 9.

At 1510, the method may include receiving, from the network entity, an assignment of a set of multiple time-frequency resources for transmission of the SRS. The operations of 1510 may be performed in accordance with examples as disclosed herein. In some examples, aspects of the operations of 1510 may be performed by a resource assignment component 930 as described with reference to FIG. 9.

At 1515, the method may include multiplexing the SRS with the data signal across the assigned set of multiple time-frequency resources in accordance with the received configuration. The operations of 1515 may be performed in accordance with examples as disclosed herein. In some examples, aspects of the operations of 1515 may be performed by a multiplexing component 935 as described with reference to FIG. 9.

At 1520, the method may include transmitting, to the network entity, the multiplexed SRS. The operations of 1520 may be performed in accordance with examples as disclosed herein. In some examples, aspects of the operations of 1520 may be performed by an SRS component 940 as described with reference to FIG. 9.

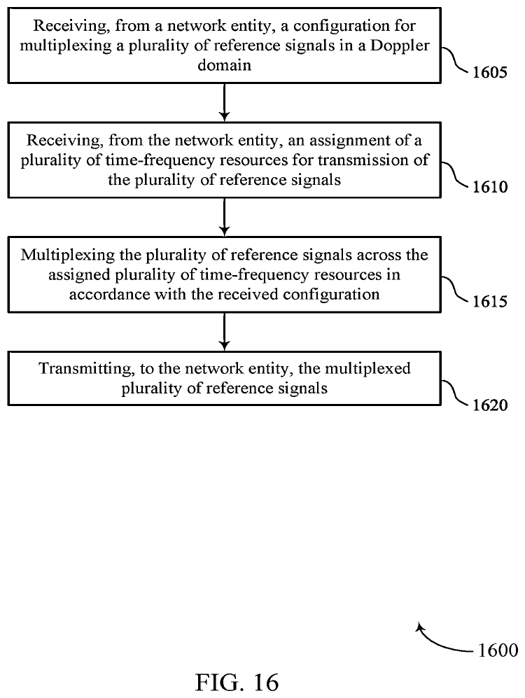

FIG. 16 shows a flowchart illustrating a method 1600 that supports techniques for enhanced SRS multiplexing in accordance with various aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a configuration for multiplexing a set of multiple reference signals in a Doppler domain. The operations of 1605 may be performed in accordance with examples as disclosed herein. In some examples, aspects of the operations of 1605 may be performed by a configuration component 925 as described with reference to FIG. 9.

At 1610, the method may include receiving, from the network entity, an assignment of a set of multiple time-frequency resources for transmission of the set of multiple reference signals. The operations of 1610 may be performed in accordance with examples as disclosed herein. In some examples, aspects of the operations of 1610 may be performed by a resource assignment component 930 as described with reference to FIG. 9.

At 1615, the method may include multiplexing the set of multiple reference signals across the assigned set of multiple time-frequency resources in accordance with the received configuration. The operations of 1615 may be performed in accordance with examples as disclosed herein. In some examples, aspects of the operations of 1615 may be performed by a multiplexing component 935 as described with reference to FIG. 9.

At 1620, the method may include transmitting, to the network entity, the multiplexed set of multiple reference signals. The operations of 1620 may be performed in accordance with examples as disclosed herein. In some examples, aspects of the operations of 1620 may be performed by a reference signal component 945 as described with reference to FIG. 9.

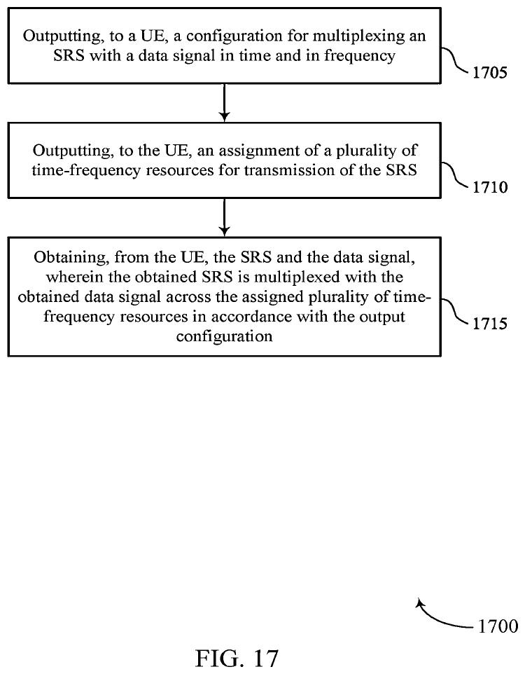

FIG. 17 shows a flowchart illustrating a method 1700 that supports techniques for enhanced SRS multiplexing in accordance with various aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting, to a UE, a configuration for multiplexing an SRS with a data signal in time and in frequency. The operations of 1705 may be performed in accordance with examples as disclosed herein. In some examples, aspects of the operations of 1705 may be performed by a multiplexing configuration component 1325 as described with reference to FIG. 13.

At 1710, the method may include outputting, to the UE, an assignment of a set of multiple time-frequency resources for transmission of the SRS. The operations of 1710 may be performed in accordance with examples as disclosed herein. In some examples, aspects of the operations of 1710 may be performed by a time-frequency resource component 1330 as described with reference to FIG. 13.

At 1715, the method may include obtaining, from the UE, the SRS and the data signal, where the obtained SRS is multiplexed with the obtained data signal across the assigned set of multiple time-frequency resources in accordance with the output configuration. The operations of 1715 may be performed in accordance with examples as disclosed herein. In some examples, aspects of the operations of 1715 may be performed by a signal component 1335 as described with reference to FIG. 13.

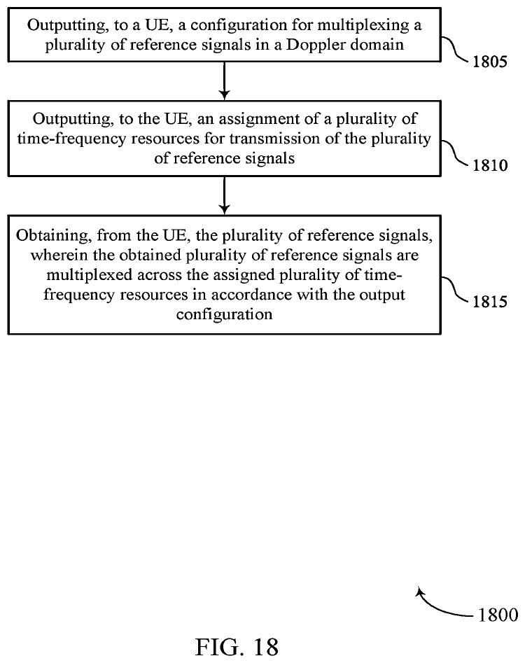

FIG. 18 shows a flowchart illustrating a method 1800 that supports techniques for enhanced SRS multiplexing in accordance with various aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a UE, a configuration for multiplexing a set of multiple reference signals in a Doppler domain. The operations of 1805 may be performed in accordance with examples as disclosed herein. In some examples, aspects of the operations of 1805 may be performed by a multiplexing configuration component 1325 as described with reference to FIG. 13.

At 1810, the method may include outputting, to the UE, an assignment of a set of multiple time-frequency resources for transmission of the set of multiple reference signals. The operations of 1810 may be performed in accordance with examples as disclosed herein. In some examples, aspects of the operations of 1810 may be performed by a time-frequency resource component 1330 as described with reference to FIG. 13.

At 1815, the method may include obtaining, from the UE, the set of multiple reference signals, where the obtained set of multiple reference signals are multiplexed across the assigned set of multiple time-frequency resources in accordance with the output configuration. The operations of 1815 may be performed in accordance with examples as disclosed herein. In some examples, aspects of the operations of 1815 may be performed by a signal component 1335 as described with reference to FIG. 13.

The following provides an overview of aspects of the present disclosure:
Aspect 1: A method for wireless communication at a UE, comprising: receiving, from a network entity, a configuration for multiplexing a SRS with a data signal in time and in frequency; receiving, from the network entity, an assignment of a plurality of time-frequency resources for transmission of the SRS; multiplexing the SRS with the data signal across the assigned plurality of time-frequency resources in accordance with the received configuration; and transmitting, to the network entity, the multiplexed SRS.
Aspect 2: The method of aspect 1, wherein multiplexing the SRS with the data signal comprises: receiving, from the network entity, an indication to rate-match the data signal around the SRS; rate-matching the data signal around the SRS in response to receiving the indication; and multiplexing the SRS with the rate-matched data signal across the assigned plurality of time-frequency resources.
Aspect 3: The method of aspect 2, wherein rate-matching the data signal around the SRS comprises: receiving, from the network entity, an indication of a comb pattern that identifies resource blocks within the assigned plurality of time-frequency resources to be used at the UE for transmission of the SRS; and rate-matching the data signal around the SRS across the assigned plurality of time-frequency resources in accordance with the indicated comb pattern.
Aspect 4: The method of aspect 1, wherein multiplexing the SRS with the data signal comprises: receiving, from the network entity, an indication of a comb pattern and frequency offset associated with the comb pattern that identify resource blocks within the assigned plurality of time-frequency resources to be used at the UE for transmission of the SRS; and multiplexing the SRS with the data signal across the assigned plurality of time-frequency resources in accordance with the indicated comb pattern and frequency offset.
Aspect 5: The method of aspect 1, wherein multiplexing the SRS with the data signal comprises: encoding the SRS using a first cover code; encoding the data signal using a second cover code that is orthogonal to the first cover code; and multiplexing the SRS with the data signal across the assigned plurality of time-frequency resources.
Aspect 6: The method of aspect 1, wherein multiplexing the SRS with the data signal comprises: multiplexing the SRS with the data signal and at least one DMRS across the assigned plurality of time-frequency resources.
Aspect 7: The method of aspect 1, wherein multiplexing the SRS with the data signal comprises: receiving, from the network entity, an indication of resource blocks within the assigned plurality of time-frequency resources to be used at the UE for transmission of the SRS; and multiplexing the SRS with the data signal across the indicated resource blocks within the assigned plurality of time-frequency resources, wherein the SRS occupies a first portion of indicated resource blocks and the data signal occupies a second portion of the indicated resource blocks.
Aspect 8: The method of any of aspects 1 through 7, wherein the SRS is used at the network entity for estimating, at the network entity, a channel for wireless communications between the UE and the network entity, sensing, at the network entity; an environment associated with the UE, or identifying, at the network entity, a position of the UE.
Aspect 9: The method of any of aspects 1 through 8, wherein the data signal comprises a PUCCH signal or a PUSCH signal.
Aspect 10: A method for wireless communication at a UE, comprising: receiving, from a network entity, a configuration for multiplexing a plurality of reference signals in a Doppler domain; receiving, from the network entity, an assignment of a plurality of time-frequency resources for transmission of the plurality of reference signals; multiplexing the plurality of reference signals across the assigned plurality of time-frequency resources in accordance with the received configuration; and transmitting, to the network entity, the multiplexed plurality of reference signals.
Aspect 11: The method of aspect 10, wherein multiplexing the plurality of reference signals comprises: receiving, from the network entity, an indication of a plurality of phase codes for multiplexing the plurality of reference signals in the Doppler domain; and multiplexing the plurality of reference signals using the indicated plurality of phase codes.
Aspect 12: The method of aspect 11, wherein multiplexing the plurality of reference signals using the indicated plurality of phase codes comprises: multiplying each reference signal of the plurality of reference signals with a respective phase code of the indicated plurality of phase codes.
Aspect 13: The method of aspect 12, wherein each respective phase code is based at least in part on a respective antenna port of plurality of antenna ports at the UE and a respective symbol within the assigned plurality of time-frequency resources.
Aspect 14: The method of any of aspects 10 through 13, wherein the plurality of reference signals are transmitted to the network entity for estimating, at the network entity, a channel for wireless communications between the UE and the network entity, sensing, at the network entity, an environment associated with the UE, or identifying, at the network entity, a position of the UE.
Aspect 15: The method of any of aspects 10 through 14, wherein the plurality of reference signals comprise SRSs, PRSs, or sensing reference signals.
Aspect 16: A method for wireless communication at a network entity, comprising: outputting, to a UE, a configuration for multiplexing a SRS with a data signal in time and in frequency; outputting, to the UE, an assignment of a plurality of time-frequency resources for transmission of the SRS; and obtaining, from the UE, the SRS and the data signal, wherein the obtained SRS is multiplexed with the obtained data signal across the assigned plurality of time-frequency resources in accordance with the output configuration.
Aspect 17: The method of aspect 16, wherein outputting the configuration comprises: outputting, to the UE, an indication of a comb pattern that identifies resource blocks within the assigned plurality of time-frequency resources to be used at the UE for transmission of the SRS, wherein the obtained data signal is rate-matched around the SRS in accordance with the indicated comb pattern.
Aspect 18: The method of aspect 17, further comprising: outputting, to the UE, an indication to rate-match the data signal around the SRS in accordance with the indicated comb pattern, wherein obtaining the data signal is based at least in part on the output indication.
Aspect 19: The method of aspect 16, wherein outputting the configuration comprises: outputting, to the UE, an indication of a comb pattern and frequency offset that identify resources blocks within the assigned plurality of time-frequency resources to be used at the UE for transmission of the SRS, wherein the obtained SRS is multiplexed in accordance with the indicated comb pattern and frequency offset.
Aspect 20: The method of aspect 16, wherein the obtained SRS is encoded using a first cover code and the obtained data signal is encoded using a second cover code that is orthogonal to the first cover code.
Aspect 21: The method of aspect 16, further comprising: obtaining, from the UE, a DMRS, wherein the obtained DMRS is multiplexed with the obtained SRS and the obtained data signal across the assigned plurality of time-frequency resources.
Aspect 22: The method of aspect 16, wherein outputting the configuration comprises: outputting, to the UE, an indication of resource blocks within the assigned plurality of time-frequency resources to be used at the UE for transmission of the SRS, wherein the obtained SRS occupies a first portion of indicated resource blocks and the obtained data signal occupies a second portion of the indicated resource blocks.
Aspect 23: The method of any of aspects 16 through 22, further comprising: estimating a channel for wireless communications between the UE and the network entity based at least in part on the obtained SRS; identifying a position of the UE based at least in part on the SRS; or sensing an environment associated with the UE based at least in part on the obtained SRS.
Aspect 24: The method of aspect 23, wherein sensing the environment associated with the UE comprises: sensing the environment associated with the UE using MIMO radar.
Aspect 25: The method of any of aspects 16 through 24, wherein the data signal comprises a PUCCH signal or a PUSCH signal.
Aspect 26: A method for wireless communication at a network entity, comprising: outputting, to a UE, a configuration for multiplexing a plurality of reference signals in a Doppler domain; outputting, to the UE, an assignment of a plurality of time-frequency resources for transmission of the plurality of reference signals; and obtaining, from the UE, the plurality of reference signals, wherein the obtained plurality of reference signals are multiplexed across the assigned plurality of time-frequency resources in accordance with the output configuration.
Aspect 27: The method of aspect 26, further comprising: outputting, to the UE, an indication of a plurality of phase codes for multiplexing the plurality of reference signals, wherein each obtained reference signal of the obtained plurality of reference signals is multiplexed using a respective phase code of the indicated plurality of phase codes.
Aspect 28: The method of aspect 27, wherein each phase code of the plurality of phase codes corresponds to a respective antenna port of plurality of antenna ports at the UE and a respective symbol within the assigned plurality of time-frequency resources.
Aspect 29: The method of any of aspects 26 through 28, wherein the plurality of reference signals are used at the network entity for estimating a channel for wireless communications between the UE and the network entity, sensing an environment associated with the UE, or identifying a position of the UE.
Aspect 30: The method of any of aspects 26 through 29, wherein the plurality of reference signals comprise SRSs, PRSs, or sensing reference signals.
Aspect 31: An apparatus for wireless communication at a UE, comprising a processor; memory coupled with the processor; and instructions stored in the memory and executable by the processor to cause the apparatus to perform a method of any of aspects 1 through 9.
Aspect 32: An apparatus for wireless communication at a UE, comprising at least one means for performing a method of any of aspects 1 through 9.
Aspect 33: A non-transitory computer-readable medium storing code for wireless communication at a UE, the code comprising instructions executable by a processor to perform a method of any of aspects 1 through 9.
Aspect 34: An apparatus for wireless communication at a UE, comprising a processor; memory coupled with the processor; and instructions stored in the memory and executable by the processor to cause the apparatus to perform a method of any of aspects 10 through 15.
Aspect 35: An apparatus for wireless communication at a UE, comprising at least one means for performing a method of any of aspects 10 through 15.
Aspect 36: A non-transitory computer-readable medium storing code for wireless communication at a UE, the code comprising instructions executable by a processor to perform a method of any of aspects 10 through 15.
Aspect 37: An apparatus for wireless communication at a network entity, comprising a processor; memory coupled with the processor; and instructions stored in the memory and executable by the processor to cause the apparatus to perform a method of any of aspects 16 through 25.
Aspect 38: An apparatus for wireless communication at a network entity, comprising at least one means for performing a method of any of aspects 16 through 25.
Aspect 39: A non-transitory computer-readable medium storing code for wireless communication at a network entity, the code comprising instructions executable by a processor to perform a method of any of aspects 16 through 25.
Aspect 40: An apparatus for wireless communication at a network entity, comprising a processor; memory coupled with the processor; and instructions stored in the memory and executable by the processor to cause the apparatus to perform a method of any of aspects 26 through 30.
Aspect 41: An apparatus for wireless communication at a network entity, comprising at least one means for performing a method of any of aspects 26 through 30.
Aspect 42: A non-transitory computer-readable medium storing code for wireless communication at a network entity, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, a configuration for multiplexing a sounding reference signal with a data signal in time and in frequency;
receiving, from the network entity, an assignment of a plurality of time-frequency resources for transmission of the sounding reference signal;
multiplexing the sounding reference signal with the data signal across the assigned plurality of time-frequency resources in accordance with the received configuration; and
transmitting, to the network entity, the multiplexed sounding reference signal.

2. The method of claim 1, wherein multiplexing the sounding reference signal with the data signal comprises:
receiving, from the network entity, an indication to rate-match the data signal around the sounding reference signal;
rate-matching the data signal around the sounding reference signal in response to receiving the indication; and
multiplexing the sounding reference signal with the rate-matched data signal across the assigned plurality of time-frequency resources.

3. The method of claim 2, wherein rate-matching the data signal around the sounding reference signal comprises:
receiving, from the network entity, an indication of a comb pattern that identifies resource blocks within the assigned plurality of time-frequency resources to be used at the UE for transmission of the sounding reference signal; and
rate-matching the data signal around the sounding reference signal across the assigned plurality of time-frequency resources in accordance with the indicated comb pattern.

4. The method of claim 1, wherein multiplexing the sounding reference signal with the data signal comprises:
receiving, from the network entity, an indication of a comb pattern and frequency offset associated with the comb pattern that identify resource blocks within the assigned plurality of time-frequency resources to be used at the UE for transmission of the sounding reference signal; and
multiplexing the sounding reference signal with the data signal across the assigned plurality of time-frequency resources in accordance with the indicated comb pattern and frequency offset.

5. The method of claim 1, wherein multiplexing the sounding reference signal with the data signal comprises:
encoding the sounding reference signal using a first cover code;
encoding the data signal using a second cover code that is orthogonal to the first cover code; and
multiplexing the sounding reference signal with the data signal across the assigned plurality of time-frequency resources.

6. The method of claim 1, wherein multiplexing the sounding reference signal with the data signal comprises:
multiplexing the sounding reference signal with the data signal and at least one demodulation reference signal across the assigned plurality of time-frequency resources.

7. The method of claim 1, wherein multiplexing the sounding reference signal with the data signal comprises:
receiving, from the network entity, an indication of resource blocks within the assigned plurality of time-frequency resources to be used at the UE for transmission of the sounding reference signal; and
multiplexing the sounding reference signal with the data signal across the indicated resource blocks within the assigned plurality of time-frequency resources, wherein the sounding reference signal occupies a first portion of indicated resource blocks and the data signal occupies a second portion of the indicated resource blocks.

8. The method of claim 1, wherein the sounding reference signal is used at the network entity for:
estimating, at the network entity, a channel for wireless communications between the UE and the network entity,
sensing, at the network entity; an environment associated with the UE, or
identifying, at the network entity, a position of the UE.

9. The method of claim 1, wherein the data signal comprises a physical uplink control channel signal or a physical uplink shared channel signal.

10. A method for wireless communication at a user equipment (UE), comprising:
receiving, from a network entity, a configuration for multiplexing a plurality of reference signals in a Doppler domain;
receiving, from the network entity, an assignment of a plurality of time-frequency resources for transmission of the plurality of reference signals;
multiplexing the plurality of reference signals across the assigned plurality of time-frequency resources in accordance with the received configuration; and
transmitting, to the network entity, the multiplexed plurality of reference signals.

11. The method of claim 10, wherein multiplexing the plurality of reference signals comprises:
receiving, from the network entity, an indication of a plurality of phase codes for multiplexing the plurality of reference signals in the Doppler domain; and
multiplexing the plurality of reference signals using the indicated plurality of phase codes.

12. The method of claim 11, wherein multiplexing the plurality of reference signals using the indicated plurality of phase codes comprises:
multiplying each reference signal of the plurality of reference signals with a respective phase code of the indicated plurality of phase codes.

13. The method of claim 12, wherein each respective phase code is based at least in part on a respective antenna port of plurality of antenna ports at the UE and a respective symbol within the assigned plurality of time-frequency resources.

14. The method of claim 10, wherein the plurality of reference signals are transmitted to the network entity for:
estimating, at the network entity, a channel for wireless communications between the UE and the network entity,
sensing, at the network entity, an environment associated with the UE, or identifying, at the network entity, a position of the UE.

15. The method of claim 10, wherein the plurality of reference signals comprise sounding reference signals, positioning reference signals, or sensing reference signals.

16. A method for wireless communication at a network entity, comprising:
outputting, to a user equipment (UE), a configuration for multiplexing a sounding reference signal with a data signal in time and in frequency;
outputting, to the UE, an assignment of a plurality of time-frequency resources for transmission of the sounding reference signal; and
obtaining, from the UE, the sounding reference signal and the data signal, wherein the obtained sounding reference signal is multiplexed with the obtained data signal across the assigned plurality of time-frequency resources in accordance with the output configuration.

17. The method of claim 16, wherein outputting the configuration comprises:
outputting, to the UE, an indication of a comb pattern that identifies resource blocks within the assigned plurality of time-frequency resources to be used at the UE for transmission of the sounding reference signal, wherein the obtained data signal is rate-matched around the sounding reference signal in accordance with the indicated comb pattern.

18. The method of claim 17, further comprising:
outputting, to the UE, an indication to rate-match the data signal around the sounding reference signal in accordance with the indicated comb pattern, wherein obtaining the data signal is based at least in part on the output indication.

19. The method of claim 16, wherein outputting the configuration comprises:
outputting, to the UE, an indication of a comb pattern and frequency offset that identify resources blocks within the assigned plurality of time-frequency resources to be used at the UE for transmission of the sounding reference signal, wherein the obtained sounding reference signal is multiplexed in accordance with the indicated comb pattern and frequency offset.

20. The method of claim 16, wherein the obtained sounding reference signal is encoded using a first cover code and the obtained data signal is encoded using a second cover code that is orthogonal to the first cover code.

21. The method of claim 16, further comprising:
obtaining, from the UE, a demodulation reference signal, wherein the obtained demodulation reference signal is multiplexed with the obtained sounding reference signal and the obtained data signal across the assigned plurality of time-frequency resources.

22. The method of claim 16, wherein outputting the configuration comprises:
outputting, to the UE, an indication of resource blocks within the assigned plurality of time-frequency resources to be used at the UE for transmission of the sounding reference signal, wherein the obtained sounding reference signal occupies a first portion of indicated resource blocks and the obtained data signal occupies a second portion of the indicated resource blocks.

23. The method of claim 16, further comprising:
estimating a channel for wireless communications between the UE and the network entity based at least in part on the obtained sounding reference signal;
identifying a position of the UE based at least in part on the sounding reference signal; or
sensing an environment associated with the UE based at least in part on the obtained sounding reference signal.

24. The method of claim 23, wherein sensing the environment associated with the UE comprises:
sensing the environment associated with the UE using multiple input and multiple output radar.

25. The method of claim 16, wherein the data signal comprises a physical uplink control channel signal or a physical uplink shared channel signal.

26. A method for wireless communication at a network entity, comprising:
outputting, to a user equipment (UE), a configuration for multiplexing a plurality of reference signals in a Doppler domain;
outputting, to the UE, an assignment of a plurality of time-frequency resources for transmission of the plurality of reference signals; and
obtaining, from the UE, the plurality of reference signals, wherein the obtained plurality of reference signals are multiplexed across the assigned plurality of time-frequency resources in accordance with the output configuration.

27. The method of claim 26, further comprising:
outputting, to the UE, an indication of a plurality of phase codes for multiplexing the plurality of reference signals, wherein each obtained reference signal of the obtained plurality of reference signals is multiplexed using a respective phase code of the indicated plurality of phase codes.

28. The method of claim 27, wherein each phase code of the plurality of phase codes corresponds to a respective antenna port of plurality of antenna ports at the UE and a respective symbol within the assigned plurality of time-frequency resources.

29. The method of claim 26, further comprising:
estimating a channel for wireless communications between the UE and the network entity based at least in part on the obtained plurality of reference signals;
identifying a position of the UE based at least in part on the obtained plurality of reference signals; or
sensing an environment associated with the UE based at least in part on the obtained plurality of reference signals.

30. The method of claim 26, wherein the plurality of reference signals comprise sounding reference signals, positioning reference signals, or sensing reference signals.
